(19) United States
(12) Patent Application Publication
(10) Pub. No.: US 2011/0279241 A1
(43) Pub. Date: Nov. 17, 2011

(54) READER/WRITER, RADIO TAG, TRANSMISSION/RECEPTION SYSTEM AND TRANSMISSION/RECEPTION METHOD

(75) Inventors: Hiroyasu SUGANO, Kawasaki (JP); Kazuki Matsui, Kawasaki (JP); Satoshi Inano, Kawasaki (JP)

(73) Assignee: FUJITSU LIMITED, Kawasaki (JP)

(21) Appl. No.: 13/114,172

(22) Filed: May 24, 2011

Related U.S. Application Data
(63) Continuation of application No. PCT/JP2008/071624, filed on Nov. 28, 2008.

(51) Int. Cl. H04Q 5/22

(52) U.S. Cl. 340/10.5

(57) ABSTRACT

A transmission unit of a reader/writer transmits, to an active-type radio tag to perform detection of a signal at a constant time interval by supplying power to a reception unit from a power supply unit for a time period, a signal including an instruction to temporarily extend the time period.

### CROSS-REFERENCE TO RELATED APPLICATIONS

This application is a continuation application of International PCT Application No. PCT/JP2008/071624 which was filed on Nov. 28, 2008.

### FIELD

The embodiments discussed herein are related to a reader/writer that transmits/receive a signal to/from a radio tag, a radio tag, a transmission/reception system and a transmission/reception method.

### BACKGROUND

In recent years, Radio Frequency Identification (RFID) technologies for performing logistics management or management of information collection and the like using a radio tag have attracted attention (see, for example, Patent Document 1). There is an active-type radio tag that has a battery inside and to which power for operation is supplied internally, and a passive-type radio tag that has no battery inside and operates by power based on a high frequency wave transmitted from a reader/writer. For the active-type radio tag, when the battery inside is consumed, change of batteries or change of the radio tag itself is needed. For this reason, in order to save power, a technique has been developed in which carrier detection is performed at a constant time interval and to transmit a response signal only when a carrier is detected (see, for example, Patent Document 2).

Patent Document 1: Japanese Raid-open Patent Publication No. 2006-106897

Patent Document 2: Japanese Raid-open Patent Publication No. 2006-338489

### SUMMARY

According to an aspect of the embodiment, a reader/writer includes a transmission unit configured to transmit, to an active-type radio tag to perform detection of a signal at a constant time interval by supplying power to a reception unit from a power supply unit for a time period, a signal including an instruction to temporarily extend the time period.

According to another aspect of the embodiment, a radio tag for transmitting/receiving a signal to/from a reader/writer includes a power supply unit, a reception unit configured to receive power supplied from the power supply unit for a time period and to detect a signal transmitted from the reader/writer at a constant time interval, and an extension unit configured to temporarily extend the time period when the reception unit receives a signal including an instruction to temporarily extend the time period.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a first illustration diagram presenting the configuration of the transmission/reception system;

FIG. 2 is a second illustration diagram presenting the configuration of the transmission/reception system;

FIG. 3 is a block diagram presenting the hardware of the reader/writer and the computer;

FIG. 4 is a block diagram presenting the hardware of the radio tag;

FIG. 5 is a first timing chart presenting the transmission/reception status of a signal between a reader/writer and a radio tag;

FIG. 6 is an illustration diagram presenting frame format examples of control information;

FIG. 7 is a second timing chart presenting the transmission/reception status of a signal between a reader/writer and a radio tag;

FIG. 8 is a third timing chart presenting the transmission/reception status of a signal between the reader/writer and a plurality of radio tags;

FIG. 9 is a first part of a flowchart presenting the procedure of a time setting process;

FIG. 10 is a second part of the flowchart presenting the procedure of a time setting process;

FIG. 11 is a third part of the flowchart presenting the procedure of a time setting process;

FIG. 12 is a fourth part of the flowchart presenting the procedure of a time setting process;

FIG. 13 is a block diagram presenting the hardware of the reader/writer and the computer according to the embodiment 2;

FIG. 14 is a block diagram presenting the hardware of the radio tag according to the embodiment 2;

FIG. 15 is an illustration diagram presenting an frame format example of control information according to the embodiment 2;

FIG. 16 is a time chart presenting the transition of a signal transmitted/received by a reader/writer and a radio tag;

FIG. 17 is an illustration diagram presenting the record layout of a data storage buffer;

FIG. 18 is a first part of a flowchart presenting the procedure of a data collection process;

FIG. 19 is a second part of the flowchart presenting the procedure of a data collection process;

FIG. 20 is a third part of the flowchart presenting the procedure of a data collection process;

FIG. 21 is a fourth part of the flowchart presenting the procedure of a data collection process;

FIG. 22 is a fifth part of the flowchart presenting the procedure of a data collection process;

FIG. 23 is a sixth part of the flowchart presenting the procedure of a data collection process;

FIG. 24 is a seventh part of the flowchart presenting the procedure of a data collection process;

FIG. 25 is a block diagram presenting the hardware of the reader/writer and the computer according to the embodiment 3;

FIG. 26 is a block diagram presenting the hardware of the radio tag according to the embodiment 3;

FIG. 27 is an illustration diagram presenting the configuration of the transmission/reception system according to the embodiment 4;

FIG. 28 is a first part of a flowchart presenting the procedure of a data collection process according to the embodiment 4;

FIG. 29 is a second part of the flowchart presenting the procedure of a data collection process according to the embodiment 4; and

FIG. 30 is a third part of the flowchart presenting the procedure of a data collection process according to the embodiment 4.

### DESCRIPTION OF EMBODIMENTS

As described above, since carrier detection is performed at a constant time interval in the conventional techniques, an active-type radio tag can be used for a long time period. However, the timing to receive signals transmitted from the reader/writer is intermittent, which leads to inconvenience in cases such as when the signal reception timing is strictly controlled. Moreover, there has been a problem that transmission of information stored in the radio tag to the reader/writer is inefficient for the same reason.

Preferred embodiments of the present invention will be explained with reference to accompanying drawings.

### Embodiment 1

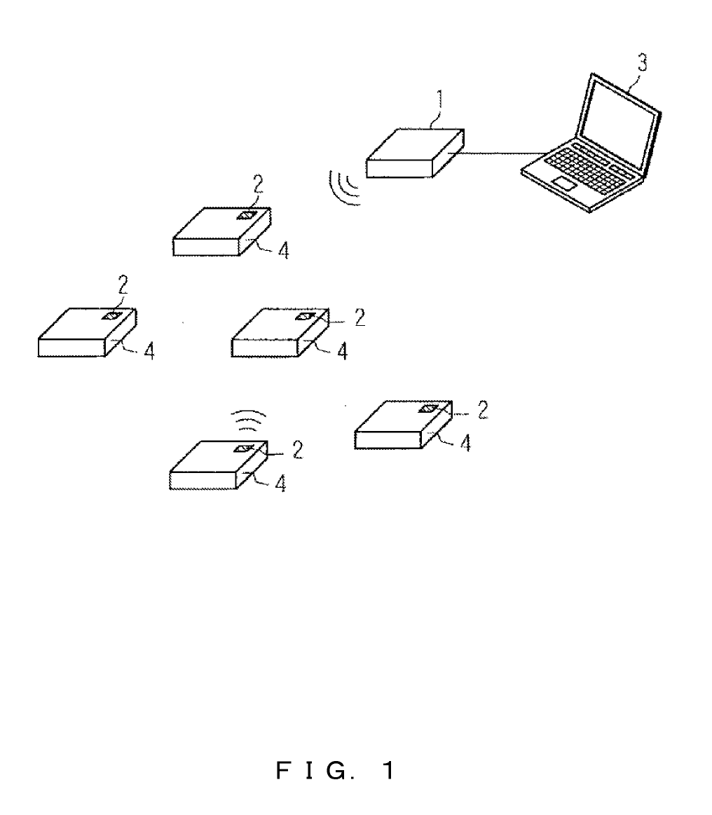

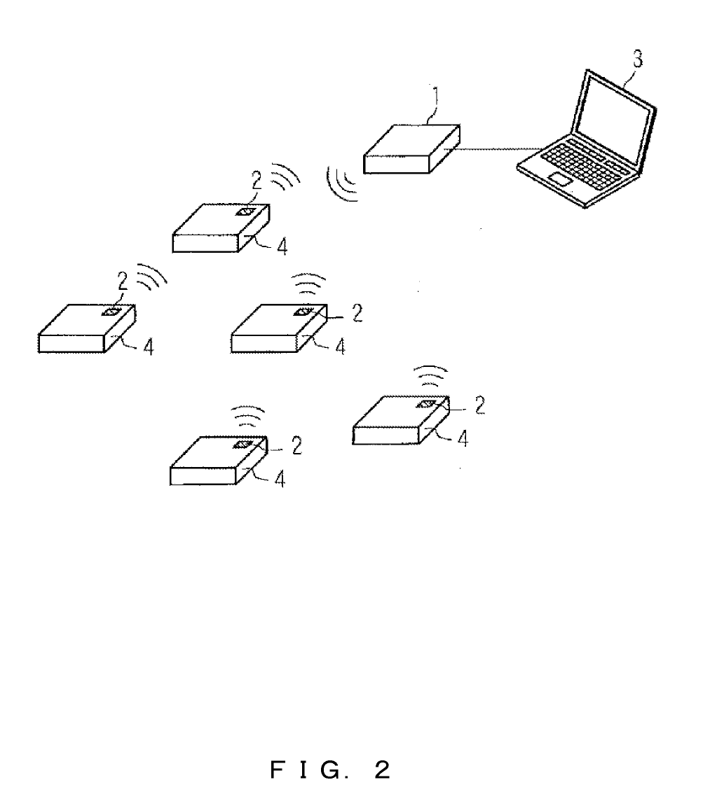

FIG. 1 and FIG. 2 are illustration diagrams presenting configurations of the transmission/reception system. The transmission/reception system includes a reader/writer 1, radio tags 2 and a computer 3. The radio tags are adhered or attached by embedding and so on to management targets 4 such as objects, containers, clothes, animals or human bodies. Hereinafter, explanation is made with an example in which the management targets 4 are objects and the radio tags 2 are attached to a part of the objects 4. The reader/writer 1 is connected to the computer 3 by wired or wireless connection, and performs transmission/reception of signals with the radio tags 2.

Meanwhile, while explanation is made with an example in which the reader/writer 1 is connected to the computer 3 by wired connection in the embodiment, transmission/reception of signals may also be made between the computer 3 that has the reader/writer 1 inside and the radio tag 2. Furthermore, while explanation is made with the example in which one unit of the reader/writer 1 is connected to the computer 3, a plurality of reader/writers 1 may be controlled by the computer 3. The radio tag 2 is of the active type that has a battery (hereinafter, referred to as the power supply unit) inside and performs detection (hereinafter, referred to as carrier sense in some instances) of signals from the reader/writer 1 at a constant time interval with power supplied from the power supply unit for a time period.

The radio tag 2 performs carrier sense with power supply at a constant time interval such as 2 seconds for a time period such as 5 ms. Meanwhile, the numerical values presented in the present embodiment are just examples and the embodiment is not limited to the values. Thus, since the radio tag 2 performs carrier sense at a constant time interval, the timing that the radio tags 2 perform carrier sense is not necessarily the same. The example in FIG. 1 presents a state in which only one radio tag 2 performs carrier sense and other radio tags 2 are not performing carrier sense.

Next, the outline of the present embodiment is explained using FIG. 2. The reader/writer 1 transmits to each of the radio tags 2 a request signal including an extension instruction to temporarily extend the time to perform reception of a control signal. When each radio tag 2 determines by carrier sense that there is a request signal transmitted from the reader/writer 1, it receives the request signal, and transmits a response signal to the request signal to the reader/writer 1. After transmitting the response signal, each radio tag 2 extends the time to perform reception of the control signal by the extension time according to the extension instruction. Accordingly, during the temporary extension time, it becomes possible for all the radio tags 2 to receive the signal from the reader/writer 1 simultaneously, as presented in FIG. 2. The reader/writer 1 transmits an instruction signal to each radio tag 2 during this extension time. After receiving the instruction signal, the radio tag 2 transmits a response signal to the reader/writer 1 again. The details of the process are explained below.

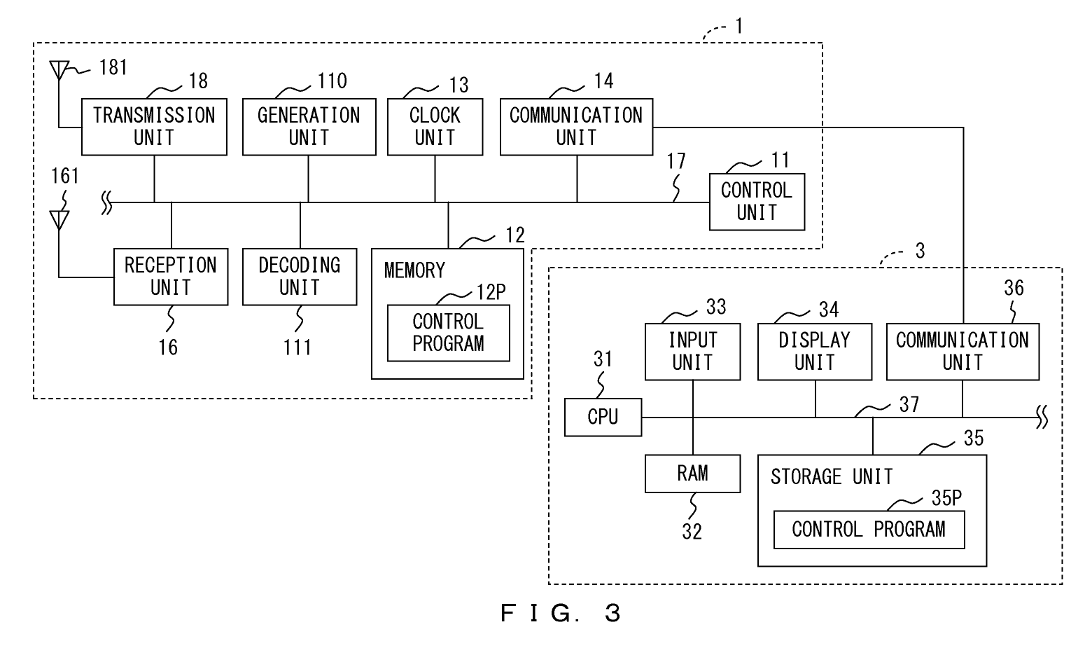

FIG. 3 is a block diagram presenting the hardware of the reader/writer 1 and the computer 3. As the computer 3, for example, a Personal Digital Assistance (PDA), a personal computer, a control apparatus used in a factory and the like, or a server computer and the like is used. Hereinafter, explanation is made assuming that the computer 3 is a personal computer 3. The personal computer 3 includes a Central Processing Unit (CPU) 31, a Random Access Memory (RAM) 32, a storage unit 35, a communication unit 36, an input unit 33 and a display unit 34, and the like. The CPU 31 is connected to each of the hardware units through a bus 37 to control them, and also executes various software functions according to a control program 35P stored in the storage unit 35. The input unit 33 is a keyboard or a mouse and the like for example and inputs control information and the like for the reader/writer 1. The display unit 34 is a liquid crystal display or an organic Electro-Luminescence (EL) display and the like for example, and displays information regarding the reader/writer 1 and the radio tag 2.

The storage unit 35 is a hard disk and the like for example, and stores the control program 35P for controlling the reader/writer 1, the Operating System (OS) and various data and the like. The communication unit 36 is a Universal Serial Bus (USB) port and the like for example, and transmits/receives information to/from a communication unit 14 of the reader/writer 1. The reader/writer 1 includes a control unit 11, a memory 12, a clock unit 13, a communication unit 14, a reception unit 16, a transmission unit 18, a generation unit 110, a decoding unit 111, a transmission antenna 181, and a reception antenna 161 and so on.

The control unit 11 is connected to each of the hardware units through a bus 17 to control them, and also executes various software functions according to a control program 12P stored in the memory 12. The communication unit 14 is a USB port and the like for example, and transmits/receives information to/from the computer 3. The clock unit outputs the time information to the control unit 11. Meanwhile, the clock unit 13 does not have to be necessarily located inside the reader/writer 1, and time information output from a clock unit (not presented in the drawing) inside the personal computer 3 may be utilized. The generation unit 110 encodes control information output from the control unit 11 according to an encoding system. The generation unit 110 outputs the encoded control information to the transmission unit 18. The transmission unit 18 modulates the encoded control information, and transmits the control signal after the modulation (RF signal) to the radio tag 2 through the transmission antenna 181.

The response signal transmitted from the radio tag 2 is received by the reception unit 16 through the reception antenna 161. The reception unit 16 demodulates the response signal and outputs response information after the demodulation to the decoding unit 111. The decoding unit 111 decodes the response information according to the encoding system mentioned above, and outputs the response information after the decoding to the control unit 11. Meanwhile, the transmission antenna 181 and the reception antenna 161 may be combined.

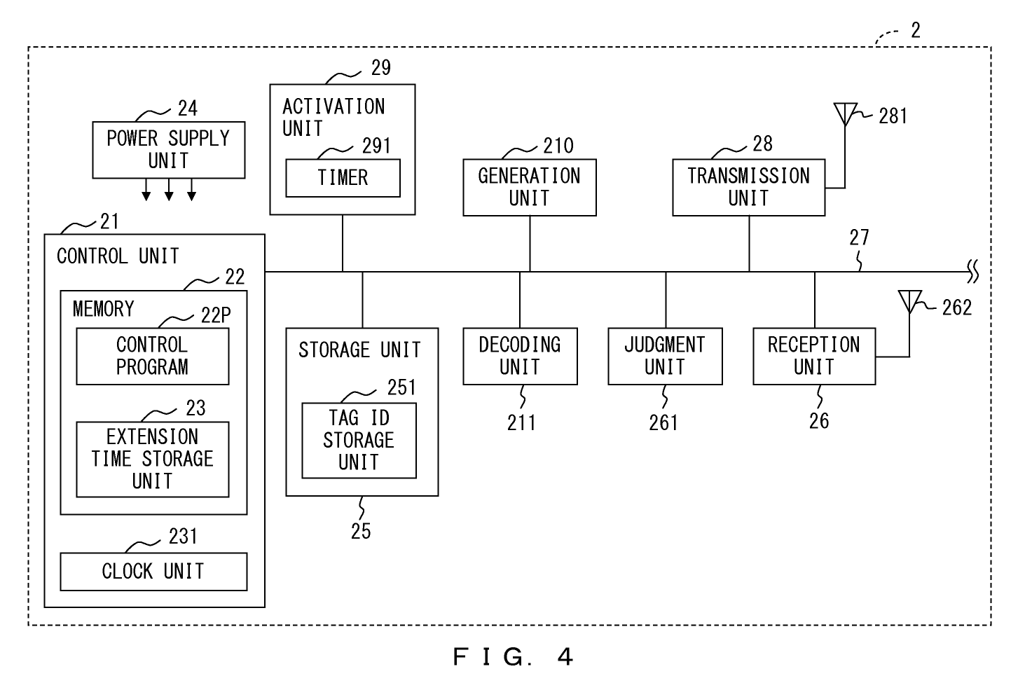

FIG. 4 is a block diagram presenting the hardware of the radio tag 2. The radio tag 2 includes a control unit 21, a memory 22, an extension time storage unit 23, a clock unit 231, a power supply unit 24, a storage unit 25, a reception unit 26, a transmission unit 28, an activation unit 29, a timer 291, a generation unit 210, a decoding unit 211, a judgment unit 261, a reception antenna 262, and a transmission antenna 281, and the like. The control unit 21 is connected to each of the hardware units through a bus 27 to control them, and also executes various software functions according to a control program 22P stored in the memory 22. The power supply unit 24 has a button battery and the like inside and supplies power to the hardware. The power supply unit 24 supplies power to the control unit 21 and the activation unit 29 when the main switch that is not presented in the drawing is turned on.

The activation unit 29 refers to the output of the timer 291 according to an instruction from the control unit 21, and provides the reception unit 26 with power from the power supply unit 24 for a time period at a constant time interval. The reception unit 26 shifts to the on state by the commencement of power supply, and shift to the off state when the power supply is discontinued as the time period elapses. The activation unit 29 refers to the output of the timer 291, and provides the reception unit 26 in the off state with power again after a prescribed time has passed since the previous commencement of power supply. The reception unit 26 performs detection of a control signal transmitted from the reader/writer 1 through the antenna 262 for a time period. The judgment unit 261 also is provided with power in the same manner as the reception unit 26 and judges the presence/absence of the control signal by comparing power intensity of the signal received through the antenna 262 with power intensity stored in advance. When the judgment unit 261 determines that there is a control signal within the time period, the reception unit 26 outputs a signal indicating reception of the control signal to the control unit 21. The clock unit 231 outputs time information that becomes a reference when the control unit 21 performs various processes.

The control unit 21 supplies power to the storage unit 25 and the decoding unit 211 to which power has not yet been provided, for a time period (100 ms for example). The reception unit 26 decodes the control signal, and outputs control information after the demodulation to the decoding unit 211. The decoding unit 211 performs decoding according to the encoding system mentioned above, and outputs control information after the decoding to the control unit 21. The control unit 21 supplies power to the storage unit 25, the generation unit 210 and the transmission unit 28 for a time period (100 ms for example). The control unit 21 reads out a unique tag ID for identifying the radio tag 2 stored in a tag ID storage unit 251 in the storage unit 25. The control unit 21 outputs response information including the tag ID to the generation unit 210. The generation unit 210 encodes the response information according to the encoding system mentioned above.

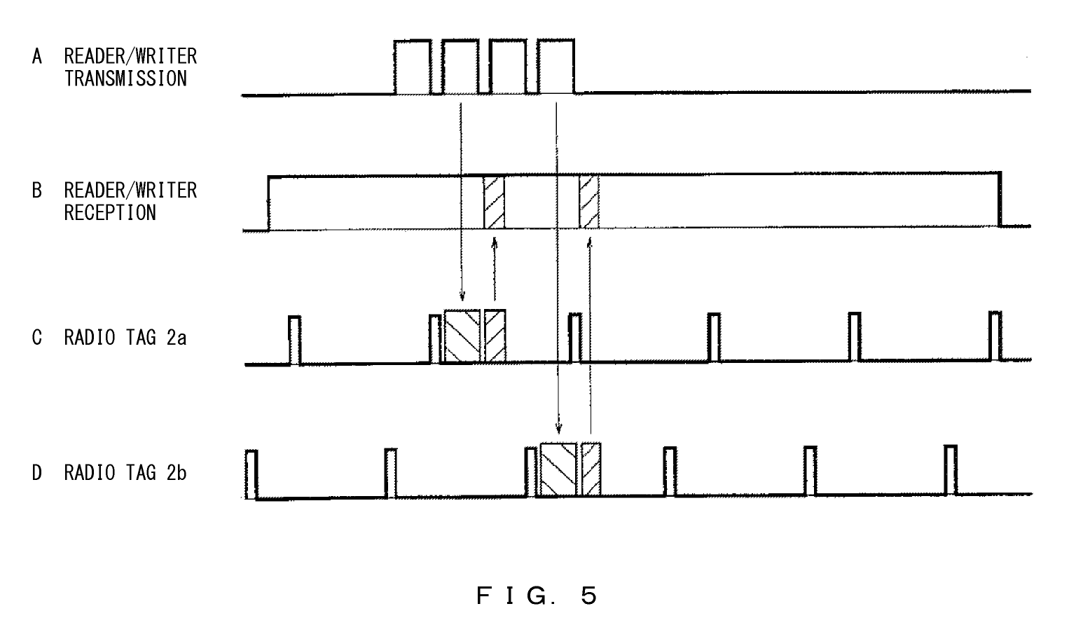

The generation unit 210 outputs the encoded response information to the transmission unit 28. The transmission unit 28 modulates the response information, and transmits the response signal after the modulation to the reader/writer 1 through the transmission antenna 281. FIG. 5 is a timing chart presenting the transmission/reception state of a signal between the reader/writer 1 and the radio tag 2. The horizontal axis in FIG. 5 is the time, and the vertical axis is the intensity to identify whether the signal is high or low. “A” in FIG. 5 is a timing chart presenting the change of a signal transmitted from the transmission unit 28 of the reader/writer 1. The control unit 11 of the reader/writer 1 successively transmits the control signal through the transmission unit 18. “B” in FIG. 5 is a timing chart presenting the change of the reception signal at the reception unit 16 of the reader/writer 1. When the reader/writer 1 is on, the reception unit 16 of the reader/writer 1 is in the state in which reception of a signal from the radio tag 2 can always be performed.

“C” in FIG. 5 is a timing chart presenting the transmission/reception state of a signal at the first radio tag 2a (represented as the radio tag 2 in some instances). As presented with outline rectangles, the radio tag 2a performs detection (carrier sense) of the control signal transmitted from the transmission unit 18 of the reader/writer 1 for a time period at a constant time interval. Hereinafter, the time during which the detection is performed is referred to as the detection time. In “C”, it is understood that the control signal is recognized in the second detection time from the left, and the control signal presented with a rectangle with downward-right oblique hatching is received. The control unit 21 of the radio tag 2a transmits a response signal including a tag ID to the reader/writer 1 through the transmission unit 28. As presented in “C” and “B”, it is understood that a response signal presented with a rectangle with downward-left oblique hatching is transmitted from the radio tag 2a to the reader/writer 1.

“D” in FIG. 5 is a timing chart presenting the transmission/reception state of a signal at the second radio tag 2b (represented as the radio tag 2 in some instances). In a similar manner, the radio tag 2b performs detection of the control signal transmitted from the transmission unit 18 of the reader/writer 1 for a time period at a constant time interval. In “D”, it is understood that the control signal is recognized and received in the third detection time from the left. The control unit 21 of the radio tag 2b transmits a response signal including a tag ID to the reader/writer 1 through the transmission unit 28. As presented in “D” and “B”, it is understood that a response signal is transmitted from the radio tag 2b to the reader/writer 1.

As presented in FIG. 5, when the control signal is transmitted from the reader/writer 1 to the plurality of radio tags 2a and 2b, the reception time differs due to the difference in the detection time. Therefore, it becomes a problem when control information for which the reception time needs to be the same is transmitted. Control information for which the reception time needs to be the same is, for example, the current time, a password that is generated based on the current time, or a deletion instruction for data in each of the radio tags 2 at the same time. In this embodiment, explanation is made with an example in which the current time is written into each of the radio tags 2. In order to solve the problem mentioned above, an extension instruction for the control signal reception time is included in control information.

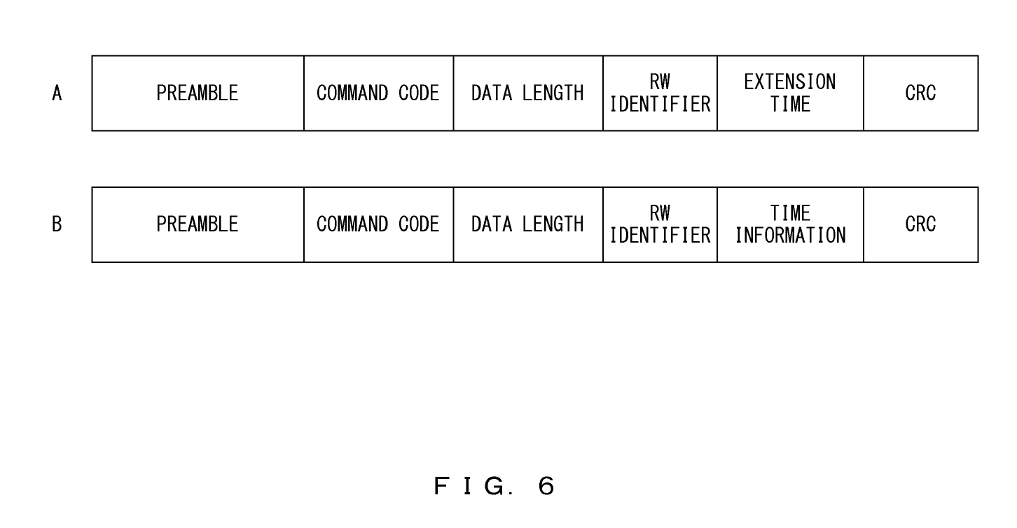

The control unit 11 of the reader/writer 1 generates control information including an extension instruction according to the control program 12P. FIG. 6 is an illustration diagram presenting frame format examples of the control information. “A” in FIG. 6 is an illustration diagram presenting a frame format example of the control signal including an extension instruction. The control information including the extension instruction includes a preamble, a command code, a data length, an RW identifier, an extension time, a Cyclic Redundancy Check (CRC), and so on. The preamble is a field for performing synchronization at the radio tag 2 side, where a predetermined fixed pattern is presented.

A code representing an acquisition request instruction for the tag ID of the radio tag 2 and an extension instruction to extend the RW identifier time and the like are described in the command code. The data length describes the data size and the like of the control information. A unique reader/writer ID for identifying the reader/writer 1 is described in the RW identifier. The extension time describes the extension time of the control signal reception time. The extension time is at least a time period that is equal to or longer than a constant time being the detection interval, preferably 1.5 to 2 times the constant time. Since the detection time is 2 seconds for example, the extension time may be 3 seconds to 4 seconds. Meanwhile, these numerical values mentioned here are just examples to simplify explanation, and the embodiment is not limited to the values.

In addition, while explanation is made with an example in which the extension time is described in the control information in the present embodiment, the extension time does not have to be necessarily transmitted, as long as an extension instruction is included in the control information. An extension time for when an extension instruction is received may be stored in the storage unit 25 of the radio tag 2 in advance. Furthermore, in the present embodiment, the extension time may be stored in the memory 12 of the reader/writer 1 in advance, or the extension time may be input from the input unit 33 of the personal computer 3 and transmitted to the reader/writer 1. The CRC is a check code for the transmission error of the control information to be transmitted. Meanwhile, while the control information also includes information such as a mask, a delimiter, and the frame length and the like, description for them are omitted as needed. Meanwhile, when the mask is described as “0”, all the radio tags 2 become the reception targets of the control signal. On the other hand, when the mask is described as “1” and the tag ID of the reception target is described, only the radio tag 2 related to the described tag ID receives the control signal. The radio tags 2 having other tag IDs discard the control signal. “B” in FIG. 6 will be explained later.

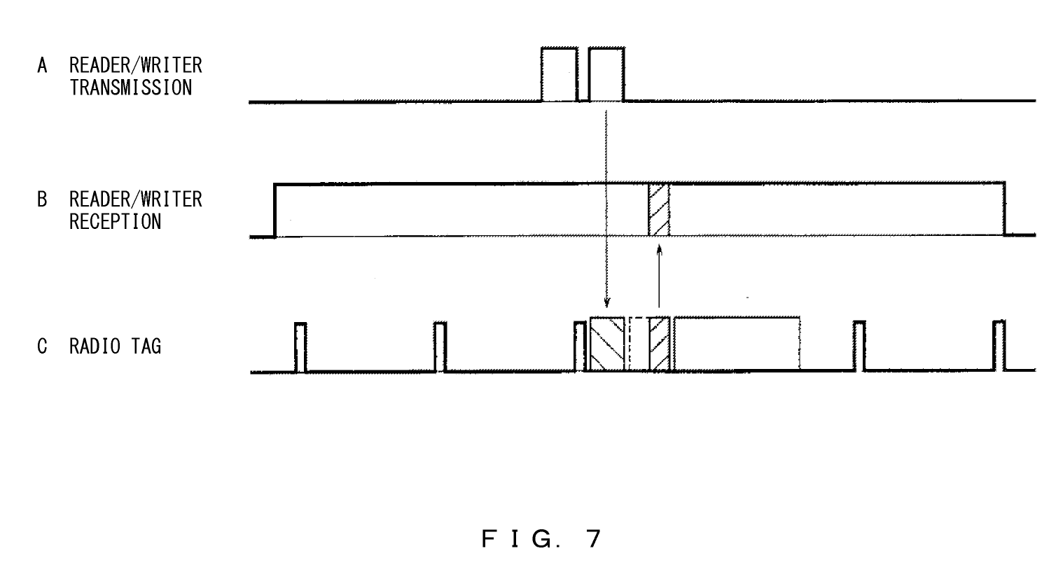

FIG. 7 is a timing chart presenting the transmission/reception state of a signal between the reader/writer 1 and the radio tag 2. “A” and “B” in FIG. 7 are similar to “A” and “B” in FIG. 5, and so description for them is omitted. “C” in FIG. 7 is a timing chart presenting the transition in a case in which the radio tag 2 receives a control signal including an extension instruction. The control unit 11 of the reader/writer 1 generates control information including the extension instruction and the extension time presented in “A” of FIG. 6 according to the control program 12P. Then, the transmission unit 18 successively transmits the control signal after modulation.

As illustrated in “C”, the judgment unit 261 of the radio tag 2 detects the presence of a control signal in a detection time. When the presence of the control signal is detected, the reception unit 26 receives the control signal, demodulates the received control signal, and outputs the control information after the demodulation to the control unit 21. The control unit 21 transmits a response signal including the tag ID read out from the tag ID storage unit 251 and information stating that the extension is to be performed, through the transmission unit 28. The control unit 21 stores the received extension time in the extension time storage unit 23 with the reception of the extension instruction as a trigger. After the transmission of the response signal, the control unit 21 controls the power unit 24, and supplies power to the reception unit 26 for the time period stored in the extension time storage unit 23. Accordingly, as illustrated in “C”, the detection time is extended. Meanwhile, the response signal is transmitted after the period enclosed by a dotted line has passed, in order to avoid collision with the response signal transmitted from other radio tags 2. This is realized by randomly selecting the transmission timing of the response signal within a prescribed range according to a random number generated in the tag.

The reader/writer 1 transmits the control information including a time setting instruction and time information to the radio tag 2 within the extended detection time. “B” in FIG. 6 is an illustration diagram presenting a frame format example of control information including a time setting instruction and time information. The control information includes a preamble, a command code, a data length, an RW identifier, time information, and a CRC and so on. A code including an acquisition instruction for the tag ID of the radio tag 2 and a write instruction of the time information into the memory 22 and the like, and so on are written in the command code. The time information describes information such as the current time output from the clock unit 13 when the control unit 11 transmits the control information.

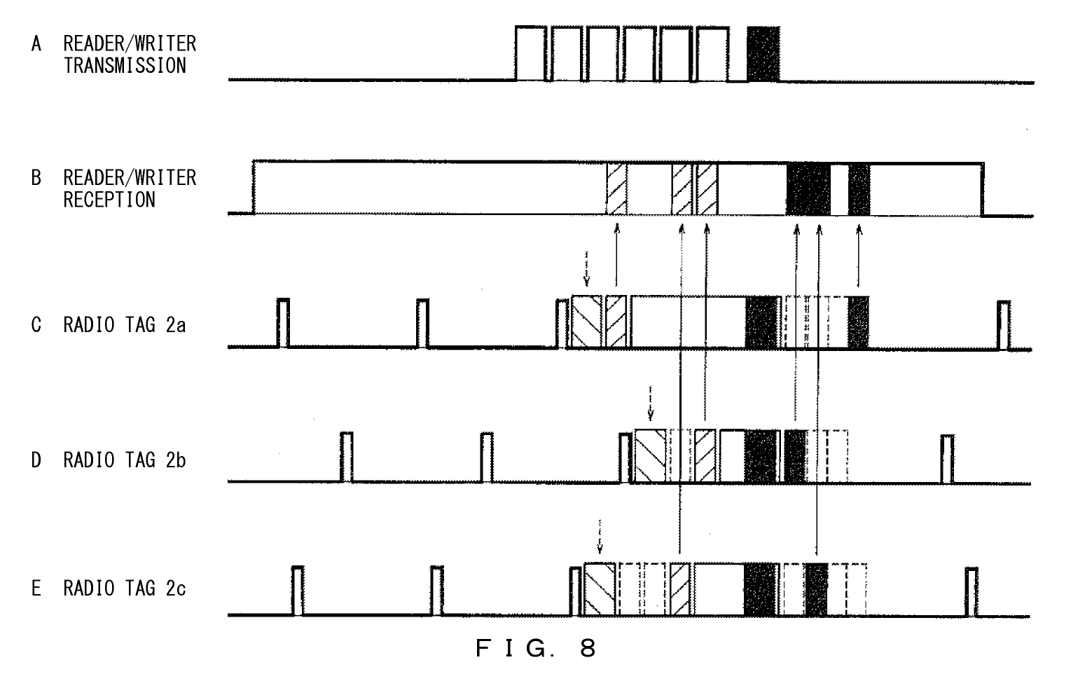

FIG. 8 is a timing chart presenting the transmission/reception state of a signal between the reader writer 1 and a plurality of radio tags 2. Explanation is made with an example in which the reader/writer 1 issues an extension instruction and a time setting instruction to three radio tags 2a, 2b and 2c (hereinafter, represented as 2 in some instances) in FIG. 8. “A” in FIG. 8 is a timing chart presenting the transition when the transmission unit 18 of the reader/writer 1 transmits a control signal. An outline rectangle indicates the transmission timing of a control signal including an extension instruction, and a black rectangle indicates the transmission timing of a control signal including a time setting instruction. The control unit 11 of the reader/writer 1 first transmits a control signal including the extension instruction presented in “A” of FIG. 6 successively for a time period to the radio tags 2a, 2b and 2c.

The reception unit 26 of the radio tags 2a, 2b and 2c detects and receives the control signal including the extension instruction in the respective detection time. “C” in FIG. 8 is a timing chart presenting the transition of a signal transmitted/received by the radio tag 2a, “D” in FIG. 8 is a timing chart presenting the transition of a signal transmitted/received by the radio tag 2b, and “E” in FIG. 8 is a timing chart presenting the transition of a signal transmitted/received by the radio tag 2c. Since the detection times of the radio tags 2a, 2b and 2c are not in synchronization, it is understood in the example in FIG. 8 that the control signal including an extension instruction is received by the radio tags 2a, 2c and 2b in this order. The radio tag 2 transmits a response signal including the read-out tag ID and information indicating that extension is to be performed according to the instruction from the control unit 21 to the reader/writer 1. Along with it, the control unit 21 stores the extension time in the memory 22, extends power supply by the power supply unit 24 to the reception unit 26 with the transmission of the response signal as a trigger, to extend the reception time.

“B” in FIG. 8 is a timing chart presenting the reception transition of a signal at the reception unit 16 of the reader/writer 1. The reception unit 16 of the reader/writer 1 receives a response signal respectively from the radio tags 2a, 2c and 2b. The reception unit 16 demodulates the response signal, and outputs reception information after demodulation to the control unit 11. The control unit 11 refers to the output from the clock unit 13, and transmits a control signal including a time setting instruction and time information to the radio tags 2a, 2b and 2c through the transmission unit 18 after a waiting time determined from the time at which the response signal was received first based on the extension time. The waiting time is equal to the extension time or may be a value obtained by subtracting an auxiliary time (such as 10 ms through 50 ms for example) in consideration of various processing times for a data reading process or a writing process or the like. Other than that, the value may be obtained by multiplying the extension time by a prescribed coefficient (such as 0.95 for example). In this embodiment, explanation is made with an example of subtracting an auxiliary time from the extension time.

The radio tags 2a, 2b and 2c receive a control signal including a time setting instruction and time information presented with the black rectangle simultaneously. The control unit 21 of the radio tag 2 stores the time information in the memory 22 according to the received time setting instruction and the time information. The control unit 21 of the radio tag 2 refers to the time information stored in the memory 22 and updates the time of the clock unit 231. When a control signal from another reader/writer 1 is received in the extension time, the radio tag 2 discards it in order to perform the time setting reliably. Specifically, the control unit 21 refers to the RW identifier of the control information received through the reception unit 26, and when it is different from the RW identifier described in the control signal including the extension instruction, discards the received control signal, that is, disregards the command included in the control information of the received control signal.

When the storage of the time is completed according to the control signal including the time setting instruction and the time information, the control unit 21 transmits a response signal indicating the tag ID read out from the tag ID storage unit 251 and the completion of the storage of the time to the reader/writer 1 through the transmission unit 28. Meanwhile, when transmitting the response signal as well, each radio tag 2 performs the transmission of the signal at a randomly selected timing to avoid collision. The control unit 21 of the radio tag 2 deletes the extension time stored in the extension time storage unit 23 after transmitting a response signal indicating the completion of the time setting. Then, the control unit 21 performs detection of a control signal again according to the normal detection time. Specifically, the off state is given except for the control unit 21 and the activation unit 29. Then, the activation unit 29 refers to the timer 291 and supplies power to the reception unit 26 for a time period, and shift to the routine to detect presence/absence of a control signal from the reader/writer 1 at a constant time interval. Accordingly, it becomes possible to deliver a control signal that requires simultaneousness reliably to the plurality of active-type radio tags 2 that perform carrier sense at a constant time interval while suppressing power consumption.

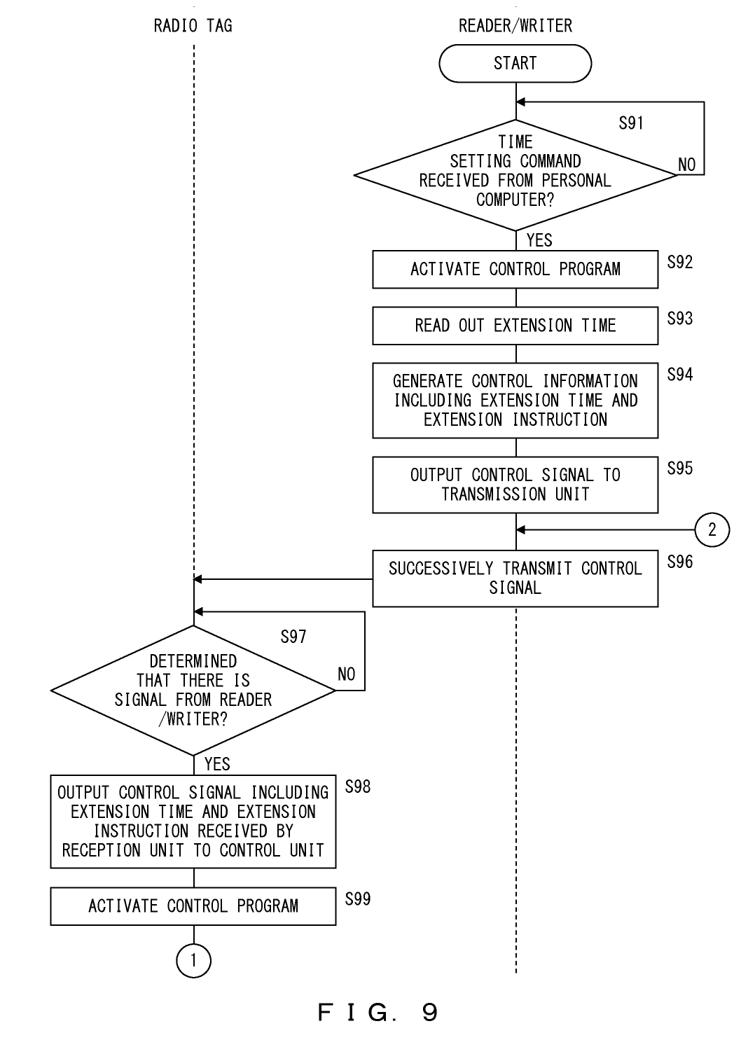

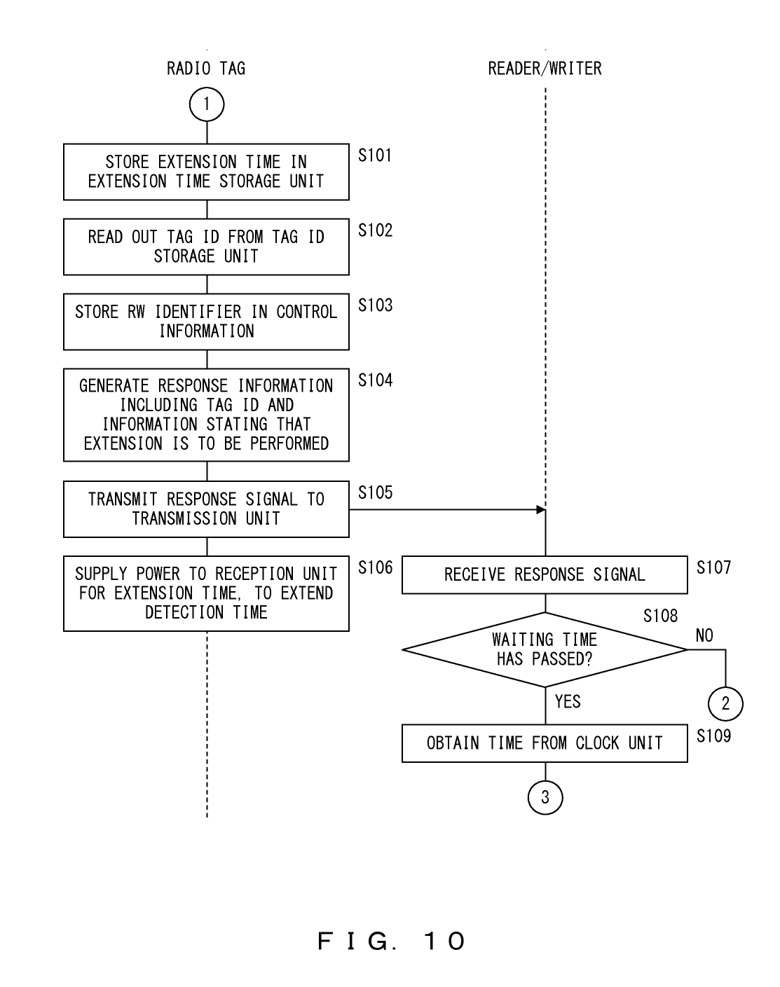

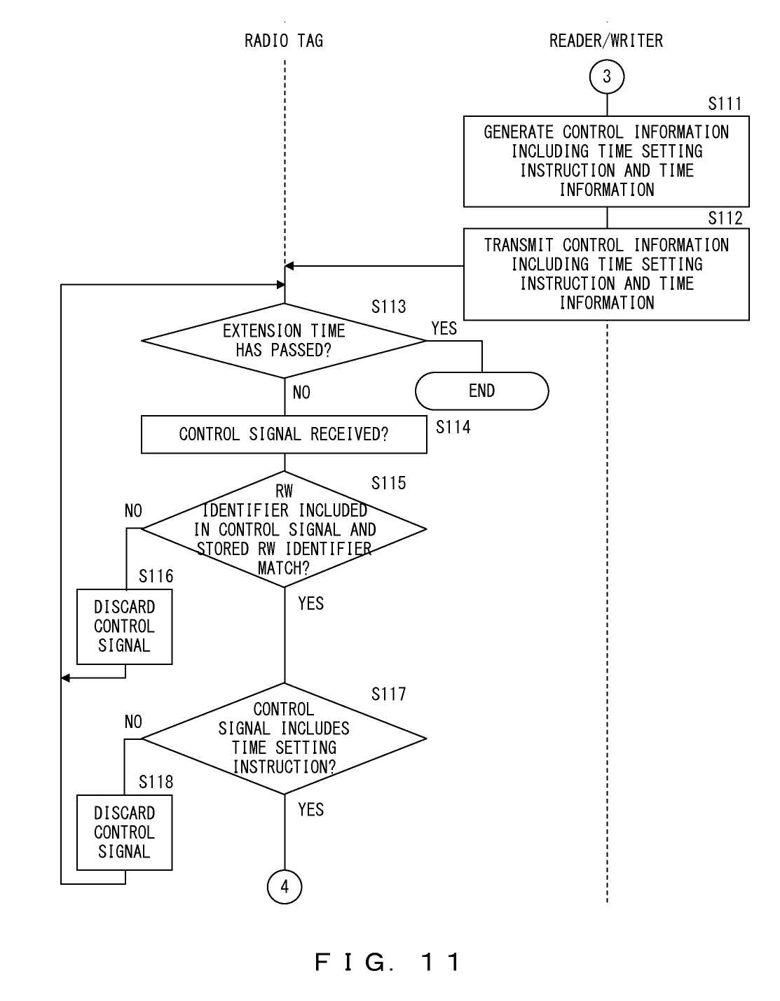

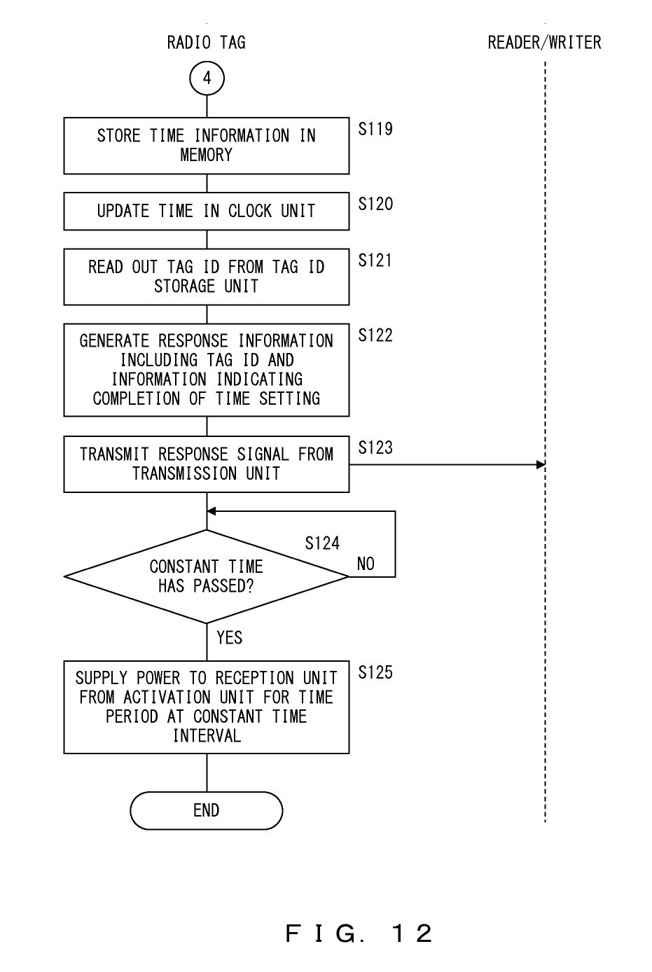

The procedure of the time setting process in the hardware described above is explained using a flowchart. FIG. 9 through FIG. 12 are a flowchart presenting the procedure of the time setting process. When the user wants each of the radio tags 2 to set the time, the user gives an instruction for the time setting to the application operating on the personal computer 3. The application can obtain the time information to be set from the clock operating on the personal computer 3, or, from a time server (not shown in the drawing) through a network such as the Internet. In addition, the user may input information indicating time setting from the input unit 33 of the personal computer 3. When the CPU 31 receives information indicating time setting, it generates a time setting command, and outputs the time setting command to the reader/writer 1 through the communication unit 36. The control unit 11 of the reader writer 1 determines whether or not a time setting command has been received from the personal computer 3, through the communication unit 14 (step S91). When the control unit 11 determines that a time setting command has not been received (NO in step S91), it waits until it receives the command.

When the control unit 11 determines that a time setting command has been received (YES in step S91), it activates the control program 12P (step S92). The control unit 11 reads out the extension time stored in the memory 12 (step S93). The control unit 11 generates control information including an extension time and an extension instruction (step S94). The control unit 11 outputs the control information to the transmission unit 18 (step S95). The transmission unit 18 modulates the control information, and successively transmits the control signal after the modulation (step S96). Meanwhile, at the time of transmission/reception of a signal between the reader/writer 1 and the radio tag 2, encoding and decoding processes are performed by the generation unit 110 and the generation unit 210, and the decoding unit 111 and the decoding unit 211, but hereinafter, explanation for them is omitted.

The activation unit 29 of the radio tag 2 refers to the time 291 and supplies power to the reception unit 26 for a time period at a constant time interval. The reception unit 26 performs carrier sense during the detection time. The judgment unit 261 determines whether or not there is a signal transmitted from the reader/writer 1 (step S97). When the judgment unit 261 determines it does not exist (NO in step S97), the same process is repeated until it exists. When the judgment unit 261 determines it exists (YES in step S97), the reception unit 26 outputs information stating that there is a signal, to the control unit 21. The control unit 21 supplies power from the power supply unit 24 for a time period to the reception unit 26, the decoding unit 211, the storage unit 25, the generation unit 210 and the transmission unit 28. The reception unit 26 receives the control signal including an extension time and an extension instruction, and outputs the received control signal to the control unit 21 through the decoding unit 211 (step S98).

The control unit 21 activates the control program 22P (step S99). When the control unit 21 determines that the command code included in the control information obtained by the demodulation by the reception unit 26 is an extension instruction, it stores the extension time in the extension time storage unit 23 (step S101). Next, the control unit 22 reads out the tag ID stored in the tag ID storage unit 251 (step S102). The control unit 21 stores the RW identifier of the reader/writer 1 described in the control information in the memory 22 (step S103). The control unit 21 generates response information including the read-put tag ID and information stating that extension is to be performed (step S104).

The control unit 21 outputs the generated response information to the transmission unit 28 according to a randomly determined transmission timing. The transmission unit 28 modulates the response information, and transmits the response signal after the modulation to the reader/writer 1 (step S105). After the transmission of the response signal, the control unit 21 stops power supply to the generation unit 210, the transmission unit 28, the decoding unit 211 and the storage unit 25. After the transmission of the response signal, the control unit 21 refers to the extension time stored in the extension time storage unit 23, and performs power supply to the reception unit 26 for the extension time, to extend the detection time (step S106). The control unit 11 of the reader/writer 1 receives the response signal through the reception unit 16 (step S107). Meanwhile, the reader/writer 1 receives the response signal from a plurality of radio tags 2.

The control unit 11 reads out the waiting time calculated in advance by the process described above from the memory 12. Then, when the control unit 11 receives the response signal from the plurality of radio tags 2, it determines whether or not the read-out waiting time has passed since it first received the response signal (step S108). When the control unit 11 determines that it has not passed (NO in step S108), shift to step S96 is performed and the above processes are repeated. When the control unit 11 determines that the waiting time has passed (YES in step S108), it obtains the time output from the clock unit 13 assuming that the reception units 26 of all the radio tags 2 that transmitted the response signals are within the extended detection time (step S109).

The control unit 11 generates control information including a time setting instruction and time information (step S111). The control unit 11 outputs the control information to the transmission unit 18. The transmission unit 18 modulates the control information including the time setting instruction and the time information, and outputs the control signal after the modulation to the radio tags 2 (step S112). The control unit 21 of the radio tag 2 determines whether or not the extension time has passed (step S113). When the control unit 21 determines that the extension time has passed (YES in step S113), the process is terminated. In this case, the control unit 21 stops power supply to the reception unit 26, and resumes carrier sense according to the normal detection time after a prescribed time has passed. When the control unit 21 determines that the extension time has not passed (NO in step S113), it receives the control signal through the reception unit 26 (step S114). When the control unit 21 receives information stating that the control signal has been received from the reception unit 26, it supplies power to the decoding unit 211. The reception unit 26 outputs the control signal to the control unit 21.

The control unit 21 determines whether or not the RW identifier included in the control signal received in step S144 matches the RW identifier stored in the memory 22 in step S103 (step S115). When the control unit 21 determines that the RW identifiers do not match (NO in step S115), the control signal received in step S114 is discarded as a control signal from a reader/writer 1 other than the reader/writer 1 that transmitted the control signal including the extension instruction (step S116). After that, the process returns to step S113 again. On the other hand, when the control unit 21 determines that the RW identifiers match (YES in step S115), shift to step S117 is performed. The control unit 21 determines whether or not the control signal includes a time setting instruction (step S117).

When the control unit 21 determines that the control signal does not include a time setting instruction (NO in step S117), the control signal received in the step S114 is discarded (S118). After that, the control unit 21 returns the process to step S113 again. When the control unit 21 determines that the control signal includes a time setting instruction (YES in step S117), time information is taken out from the control signal, and the time information is stored in the memory 22 (step S119). The control unit 21 of the radio tag 2 refers to the time information stored in the memory 22 and updates the time of the clock unit 231 in the control unit 21 (step S120). Accordingly, the time is updated in the state in which synchronization is realized between the radio tags 2. The control unit 21 supplies power to the storage unit 25, the generation unit 210 and the transmission unit 28. The control unit 21 reads out the tag ID from the tag ID storage unit 251 (step S121). The control unit 21 generates response information including the tag ID and information indicating the completion of the time setting (step S122).

The control unit 21 outputs the response information to the transmission unit 28. The transmission unit 28 modulates the response information, and transmits the response signal after the modulation to the reader/writer 1 (step S123). After the transmission of the response signal, the control unit 21 stops power supply to the generation unit 210, the transmission unit 28, the storage unit 25, the decoding unit 211 and the reception unit 26. In addition, after the transmission of the response signal, the control unit 21 determines whether or not a constant time has passed (step S124). The constant time may be set as two seconds for example.

When the control unit 21 determines that the constant time has not passed (NO in step S124), it waits until the constant time has passed. On the other hand, when the control unit 21 determines that the constant time has passed (YES in step S124), power supply is performed by the activation unit 29 to the reception unit 26 for a time period at a constant time interval (step S125). Accordingly, each of the radio tags 2 resumes carrier sense according to the normal detection time.

### Embodiment 2

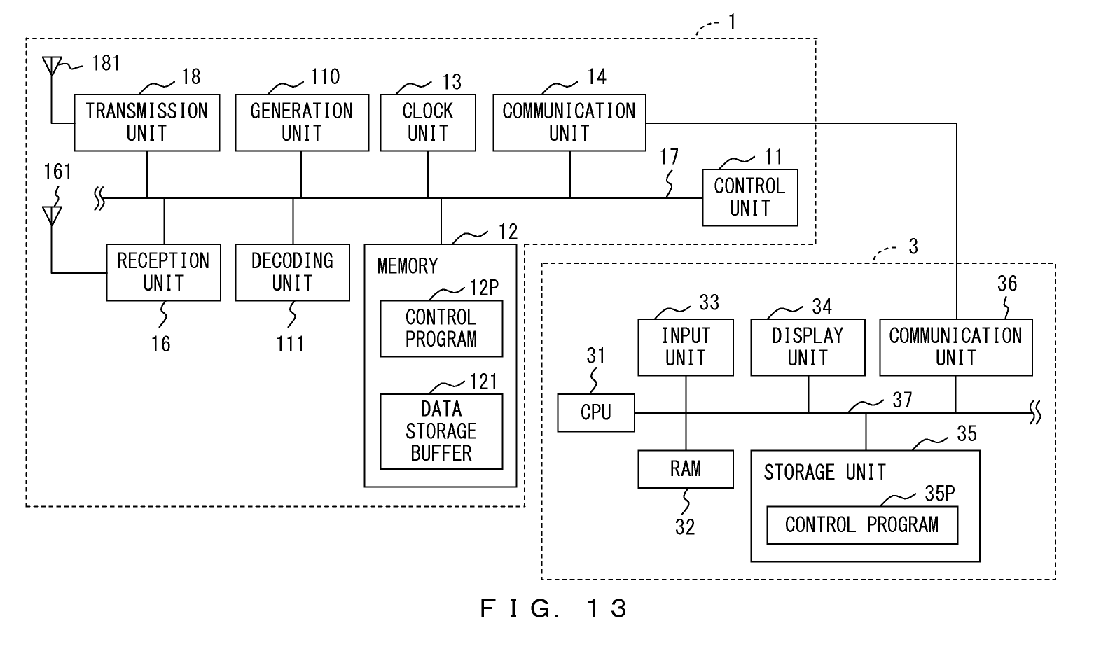

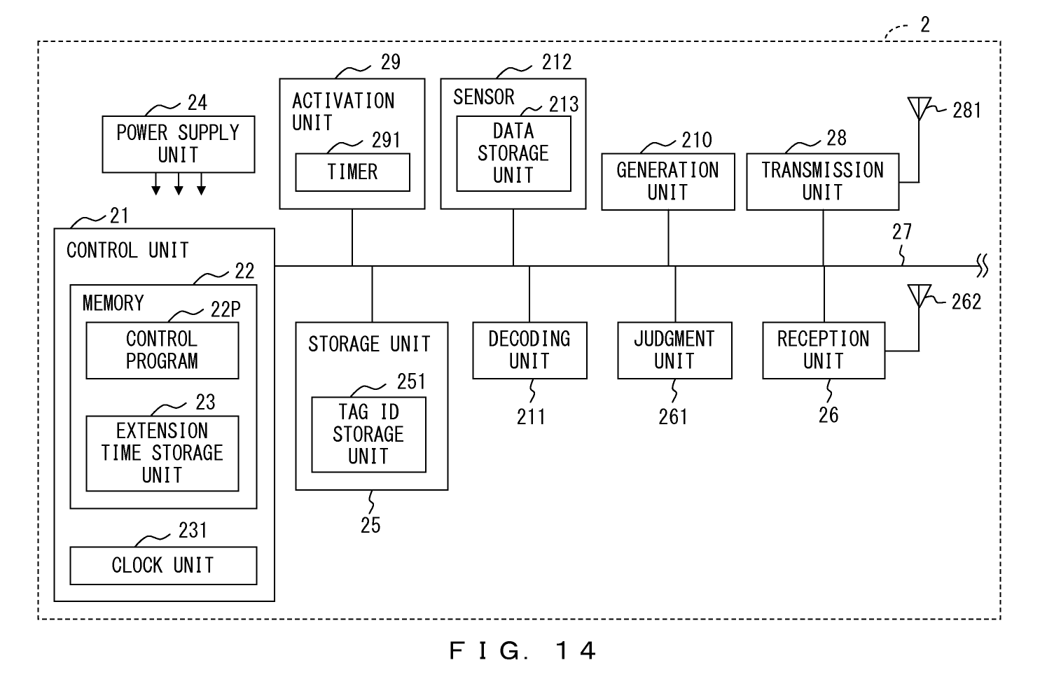

Embodiment 2 relates to an embodiment in which data stored in the radio tag 2 is collected by the reader/writer 1. FIG. 13 is a block diagram presenting the hardware of the reader/writer 1 and the personal computer 3 according to embodiment 2, and FIG. 14 is a block diagram presenting the hardware of the radio tag 2 according to embodiment 2. A data storage buffer 121 to store data transmitted from the radio tag 2 is newly provided in the memory 12 of the reader/writer 1 as presented in FIG. 13. The various data are data detected by a sensor 212 mounted on the radio tag 2 as presented in FIG. 14. Meanwhile, in this embodiment, in order to simplify explanation, explanation is made with an example in which data of one radio tag 2 is collected by designating a tag ID of the radio tag 2, but the embodiment is not limited to the example. Data may be collected from a plurality of radio tags by a similar process.

For example, various sensors including a temperature sensor, a humidity sensor, an acceleration sensor, an angular velocity sensor, a pressure sensor or a magnetic sensor and the like are used as the sensor 212. Hereinafter, explanation is made with an example in which the sensor 212 is a temperature sensor that detects temperature. The sensor 212 stores detected temperature data in a data storage unit 213. The sensor 212 receives power supply from the power supply unit 24 according to an instruction from the activation unit 29 for a time period (10 minutes for example) and at a constant time interval (1 minutes for example), and detects temperature of its surrounding at a prescribed sampling period. The sensor 212 stores the detected temperature in the data storage unit 213 together with time information output from the clock unit 231 (hereinafter, referred to as the measurement time). Since the data storage unit 213 may be storing a large amount of data, in this embodiment, an extension process of the detection time is performed, and the data readout process is performed in a divided manner.

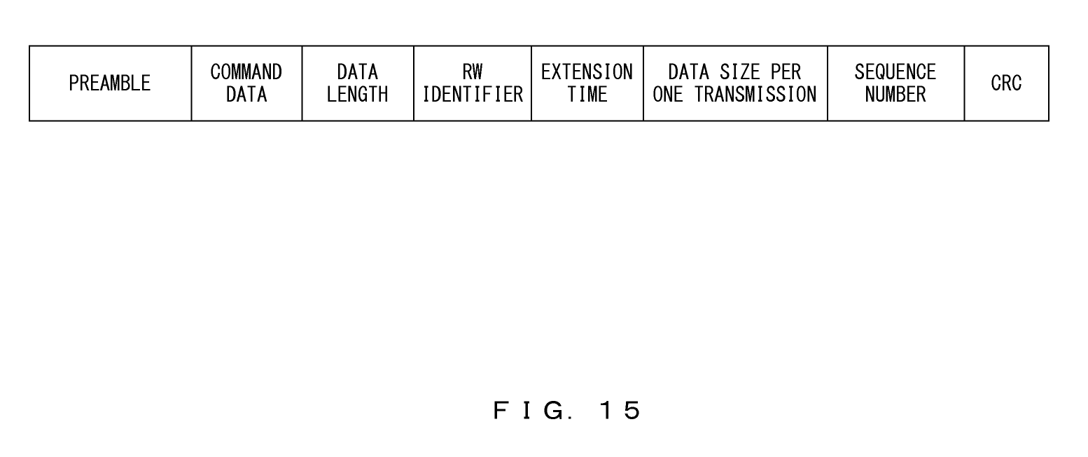

When an instruction for reading out temperature data in the radio tag 2 is received from the personal computer 3, the control unit 11 generates control information including an extension time and an acquisition request instruction for dividing temperature data stored in the data storage unit 213 and transmitting in multiple times. FIG. 15 is an illustration diagram presenting a frame format example of control information according to embodiment 2. The acquisition request instruction for dividing temperature data stored in the data storage unit 213 and transmitting in multiple times is specified in the command code.

The extension time may be any time longer than the time interval at which the reader/writer 1 can receive temperature data and transmit the control signal successively. Here, it is assumed as 1 second for example. The data size per one transmission describes the data size at the time when temperature data are transmitted in a divided manner. In this embodiment, in order to simplify explanation, explanation is made with an example in which temperature data of 1 kb is divided and transmitted in eight times. In this case, the data size per one transmission is 128 b. The sequence number is a successive number indicating the order of the divided data. The control unit 11 successively transmits the control signal modulated in the transmission unit 18 to the radio tag 2.

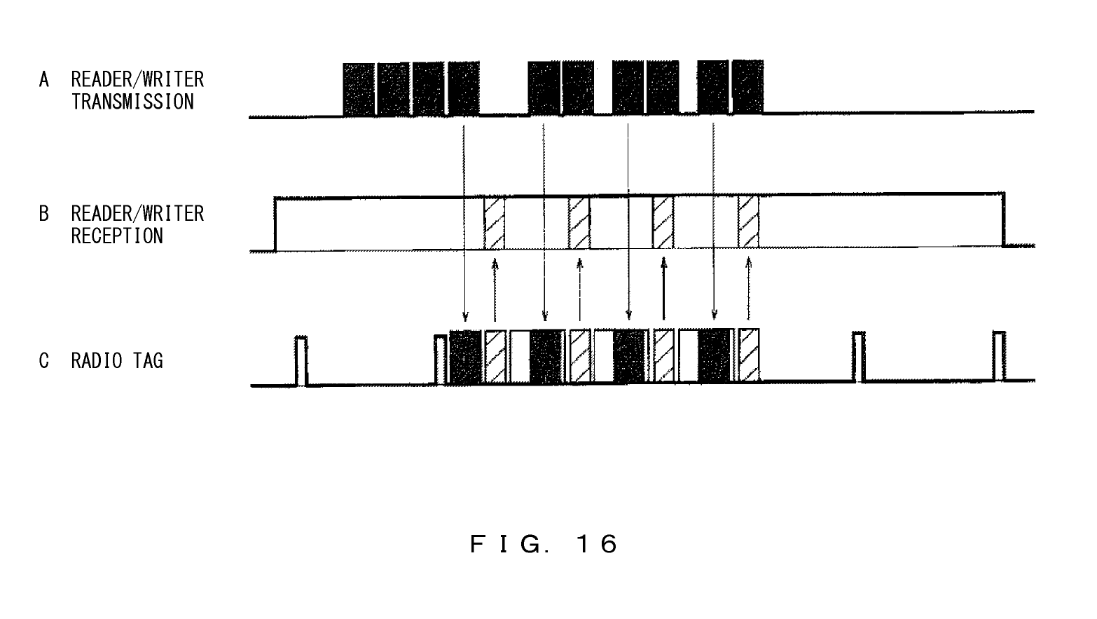

FIG. 16 is a timing chart presenting the transition of a signal transmitted/received between the reader/writer 1 and the radio tag 2. “A” in FIG. 16 is a timing chart presenting the transition of a control signal including an extension instruction and an acquisition request instruction transmitted by the transmission unit 18 of the reader/writer 1. “C” in FIG. 16 is a timing chart presenting the transition of a signal transmitted/received at the reception unit 26 and the transmission unit 28 of the radio tag 2. As illustrated in “C”, the radio tag 2 detects the control signal in the second detection time. When a control signal including a temporary extension instruction for a time period and an acquisition request instruction, the control unit 21 of the radio tag 2 supplies power to the sensor 212, the storage unit 25, the decoding unit 211, the generation unit 210 and the transmission unit 28. The reception unit 26 completes the detection time and power supply is terminated.

The control unit 21 of the radio tag 2 stores the extension time in the extension time storage unit 23. In addition, the control unit 21 reads out the tag ID from the tag ID storage unit 251. Furthermore, the control unit 21 reads out temperature data corresponding to the data size per one transmission. Meanwhile, the control unit 21 has stored the address of the data storage unit 213 corresponding to the sequence number in the memory 12. When an acquisition request instruction and a sequence number is received from the reader writer 1, the control unit 21 reads out temperature data existing in the address corresponding to the sequence number. Then, the control unit 21 transmits the read-out temperature data corresponding to the sequence number to the reader/writer 1. The control unit 21 of the radio 21 generates response information including the read-out tag ID, temperature data, the sequence number of data to be transmitted, and, information about whether or not there remain any unsent data (hereinafter, referred to as unsent data presence/absence information). Meanwhile, while the measurement time may be included in the response information with the temperature data, its description is omitted in order to simplify explanation. The control unit 21 transmits the response information to the transmission unit 28. The transmission unit 28 modulates the response information, and transmits the response signal after the modulation to the reader/writer 1. Temperature data that has already been read out and transmitted is left without change in the data storage unit 213.

After that, the control unit 21 stops power supply to the sensor 212, the storage unit 25, the generation unit 210, the decoding unit 211 and the transmission unit 28. The control unit 21 next supply power to the reception unit 26 according to the extension time stored in the extension time storage unit 23. Accordingly, the control signal reception time of the reception unit 26 is extended. “B” in FIG. 16 is a timing chart presenting the reception state transition of the response signal at the reception unit 26 of the reader/writer 1. As presented in “B” and “C”, when a response signal is transmitted from the radio tag 2, the reader/writer 1 receives it. After the transmission of the response signal, the radio tag 2 performs reception of the control signal during the extension time again by the reception unit 26.

When a reception signal is received, the reception unit 16 of the reader/writer 1 performs demodulation and outputs the response information after the demodulation to the control unit 11. The control unit 11 stores the received temperature data in the data storage buffer 121. The control unit 11 checks the unsent data presence/absence information, and when there remains any unsent data, refers to the output of the clock unit 13, and transmits a control signal including the extension time, the next sequence number, and an acquisition request instruction successively to the radio tag 2, in the period until the extension time has passed, as in FIG. 16A. By repeating the above process, temperature data corresponding to eight times, that is, 1 kb are accumulated in the data storage buffer 121. Meanwhile, the process may be terminated when there is no unsent data in the data storage unit 213 of the radio tag 2.

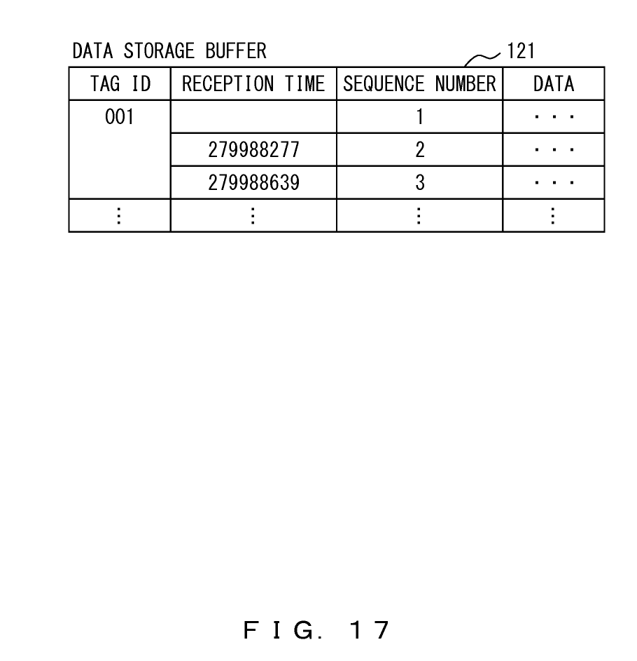

FIG. 17 is an illustration diagram presenting the record layout of the data storage buffer 121. The data storage buffer 121 includes a tag ID field, a reception time field, a sequence number field and a data field. The tag ID field stores the tag ID of the radio tag 2 that is the read out target for temperature data. The reception time field stores information of the time output from the clock unit 13 when the first response signal is received. In the example in FIG. 17, as the information of the time, the elapsed time from a specific reference time is expressed in the order of millisecond (ms). The data field stores temperature data in association with the number. When the control unit 11 of the reader/writer 1 reads out a prescribed amount of data from the radio tag 2, it transmits all the data such as the temperature data and so on stored in the data storage buffer 121 to the personal computer 3.

The CPU 31 of the personal computer 3 stores all the data including the temperature data and so on received through the communication unit 36 in the storage unit 35, and displays them on the display unit 34 as needed. As illustrated in FIG. 16, even the radio tag 2 that performs carrier sense at a constant time interval, since concentrated collection of data can be performed due to the extension instruction, data collection can be done in a shorter period of time. In addition, when transmitting/receiving a large volume of data, if data transmission/reception needs to be performed again due to an error, since the data collection is performed in a divided manner, such a problem can also be solved.

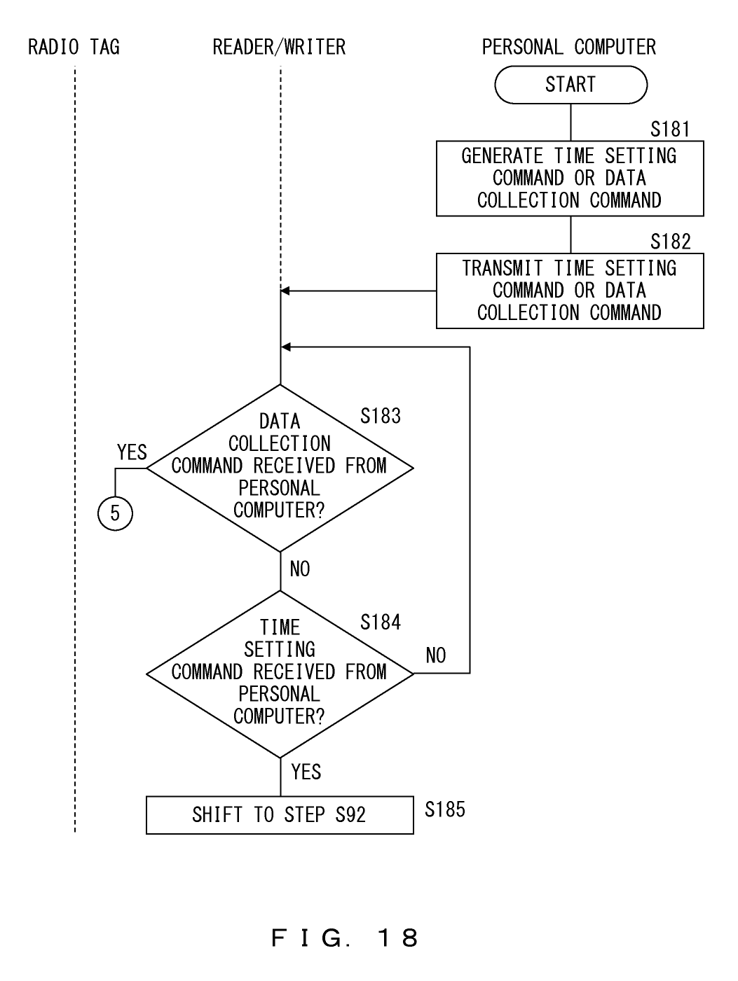

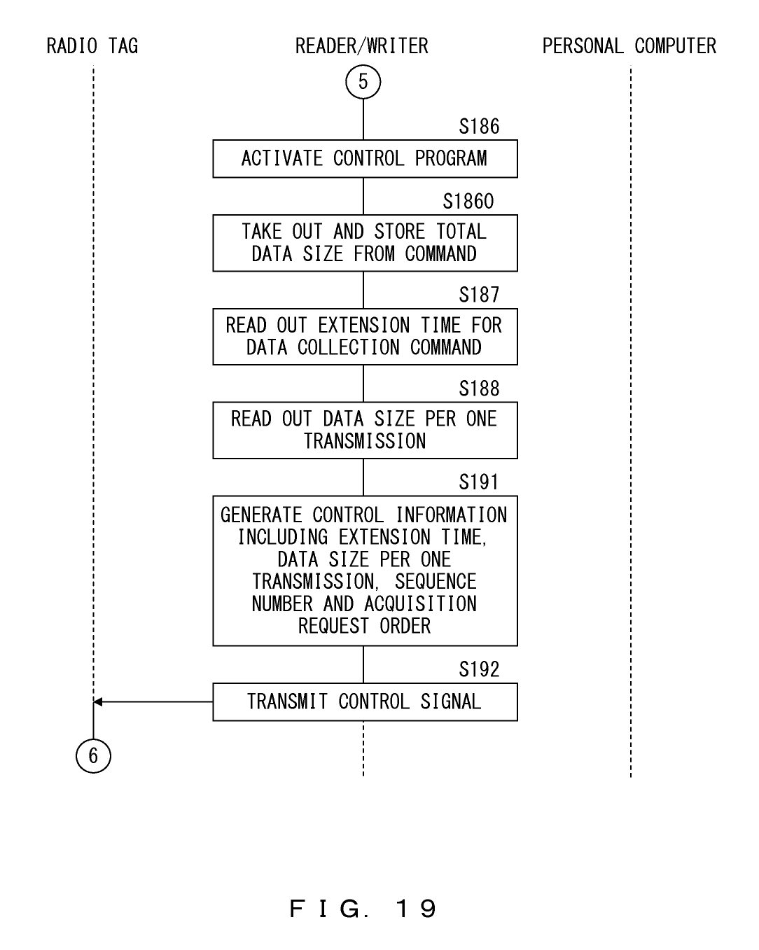

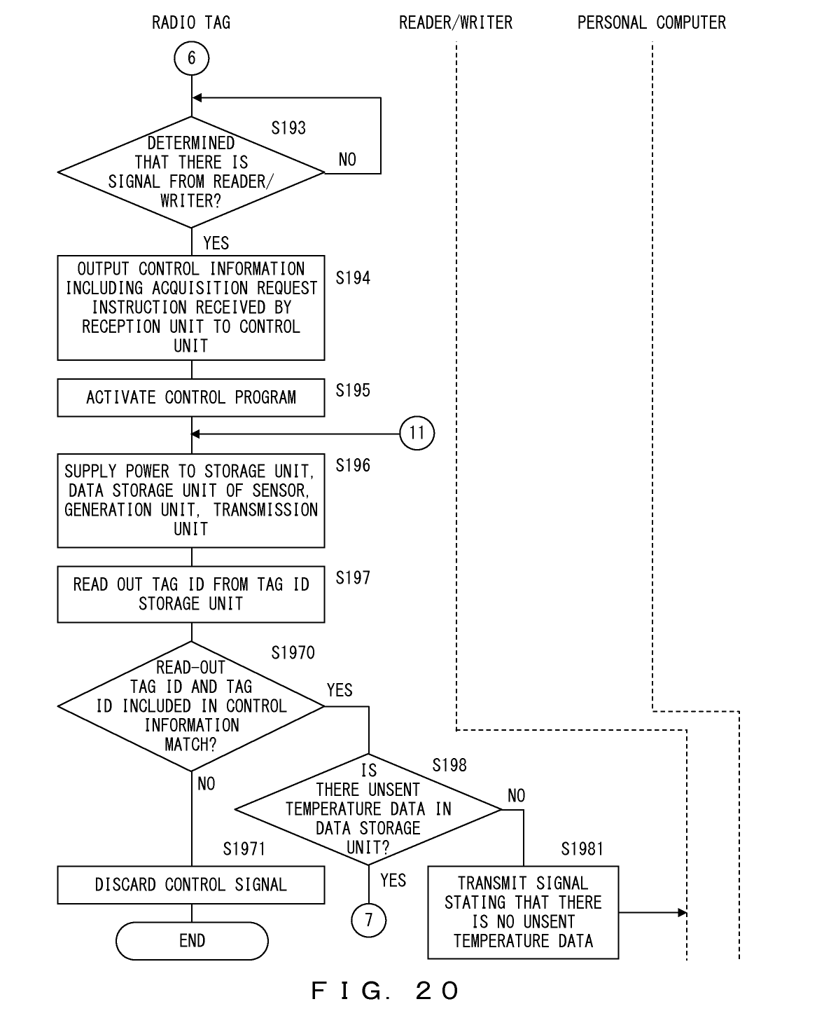

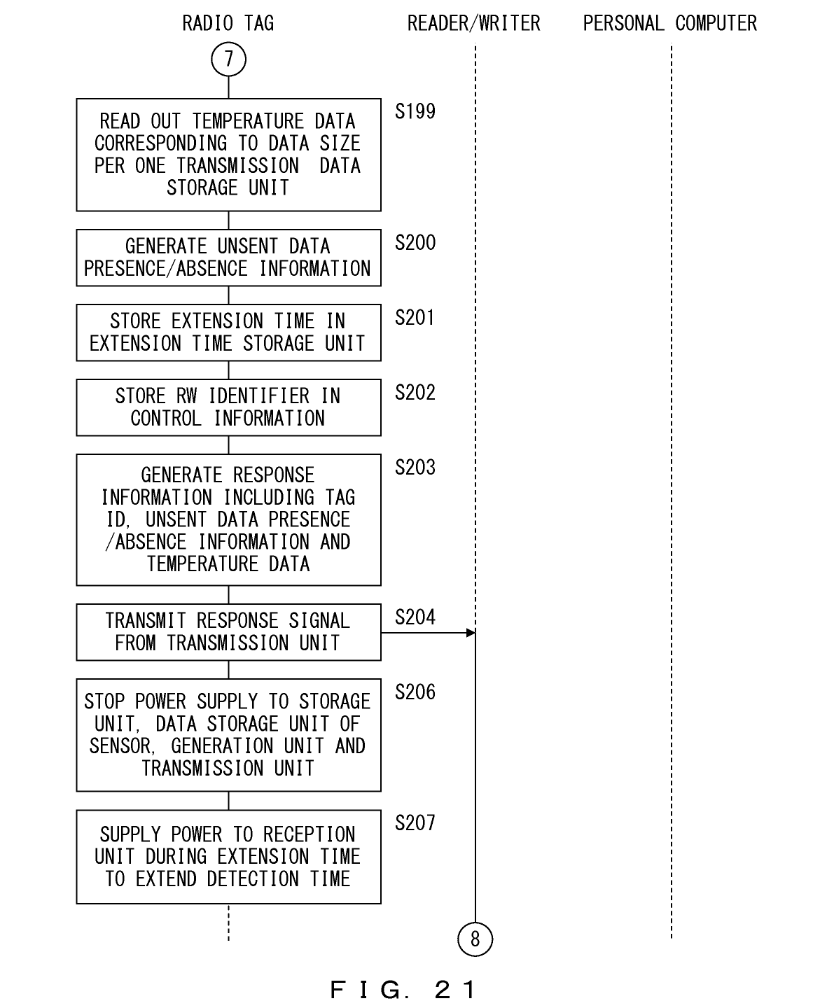

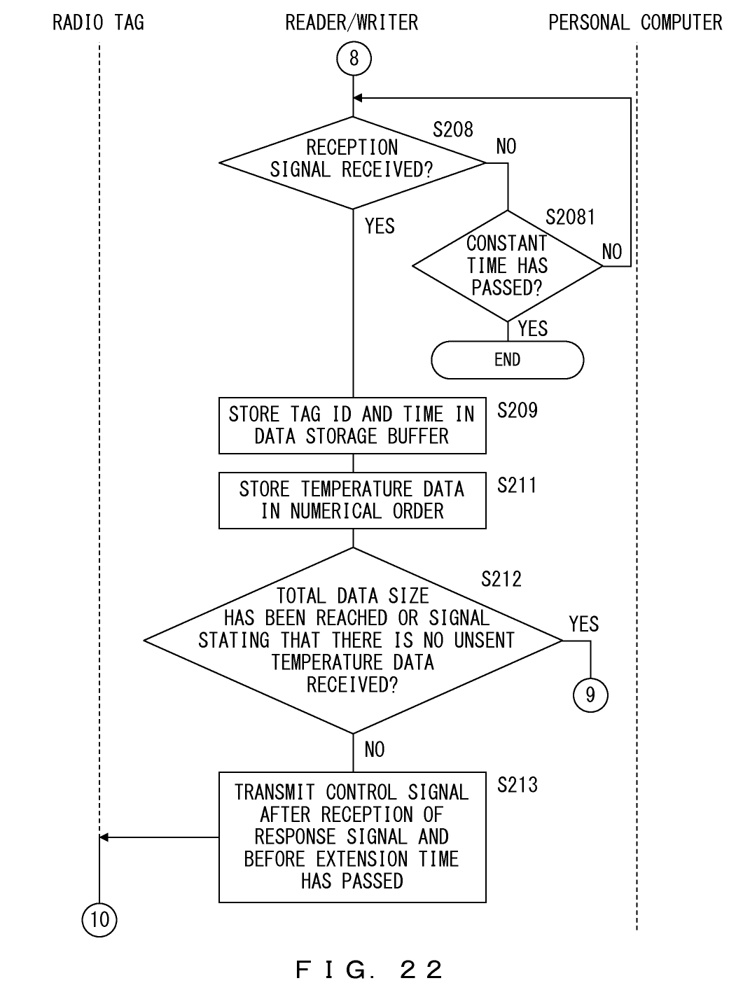

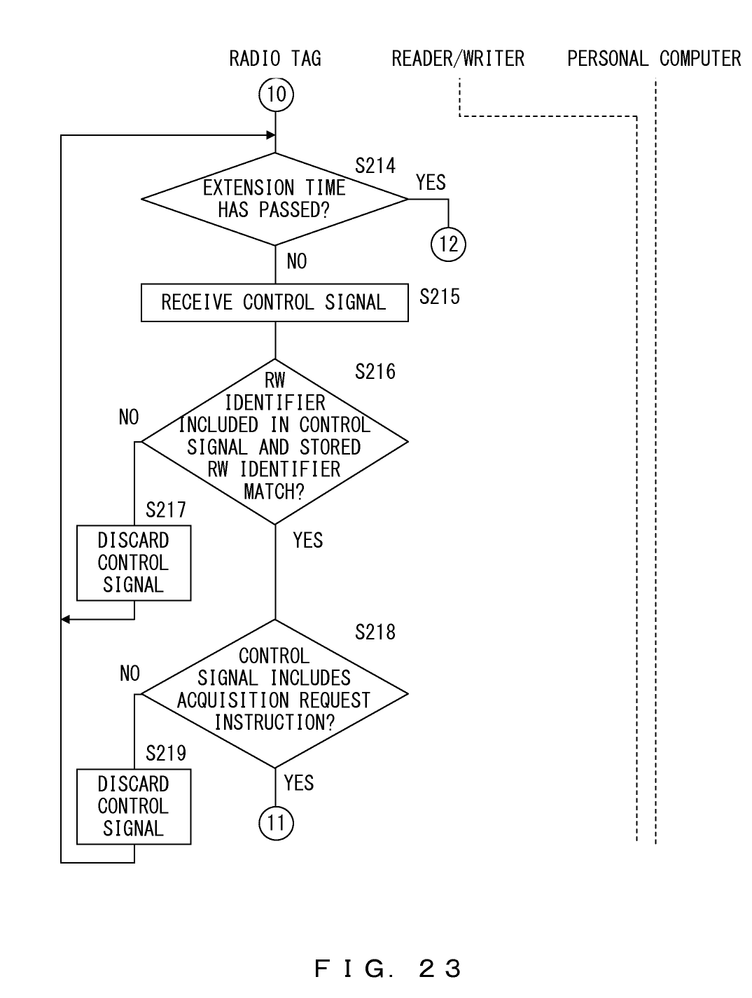

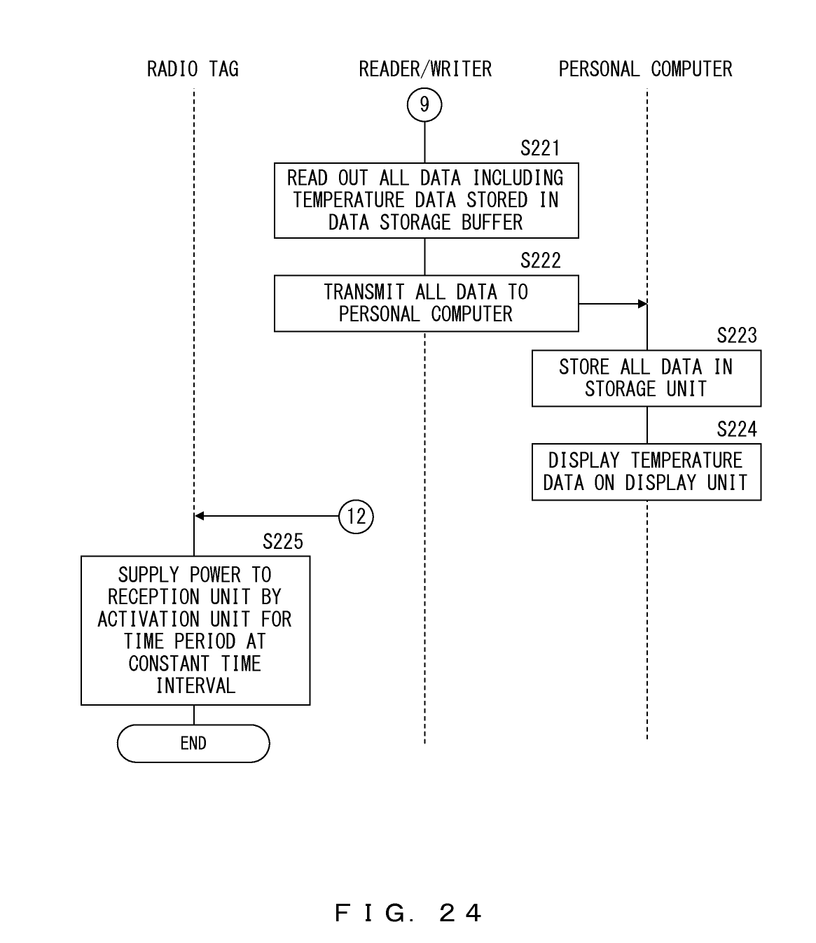

FIG. 18 through FIG. 24 are a flowchart presenting the procedure of the data collection process. The CPU 31 on the personal computer 3 generates a time setting command performing the time setting in the radio tag 2 or a data collection command for collecting temperature data according to this embodiment as needed according the process procedure by an application program and the like (step S181). The data collection command specifies the overall data size of the temperature data desired to be collected. The CPU 31 transmits the generated time setting command or the data collection command to the reader/writer 1 through the communication unit 36 (step S182).

The control unit 11 of the reader/writer 1 determines whether or not a data collection command has been received from the personal computer 3 (step S183). When the control unit 11 determines that the data collection command has not been received (NO in step S183), whether or not a time setting command has been received from the personal computer 3 is determined (step S184). When the control unit 11 determines that the time setting command has not been received (NO in step S184), it returns the process to step S183 again. When the control unit 11 determines that the time setting command has been received (YES in step S184), shift to step S92 described in embodiment 1 is performed (step S185).

When the control unit 11 determines that the data collection command has been received (YES in step S183), it activates the control program 12P (step S186). The control unit 11 takes out the overall data size specified in the data collection command, and stores it as the total data size in the memory 12 (step S1860). The control unit 11 reads out the extension time set for the data collection command from the memory 12 (step S187). The control unit 11 reads out the data size per one transmission from the memory 12 (step S188). Furthermore, the control unit 11 sets 1 as the sequence number. The control unit 11 sets control information including the extension time, the data size per transmission, the sequence number, and the acquisition request instruction (step S191).

The control unit 11 outputs control information to the transmission unit 18. The transmission unit 18 transmits the control signal after modulation to the radio tag 2 (step S192). Meanwhile, in this example, “1” is described in the mask in the control signal to perform data collection for one radio tag 2, and the tag ID of one radio tag 2 to be the target is described. The activation unit 29 of the radio tag 2 refers to the timer 291, and supplies power to the reception unit 26 at a constant time interval. The reception unit 26 performs carrier sense during the detection time. The judgment unit 261 determines whether or not there is a signal transmitted from the reader/writer 1 (step S193). When the judgment unit 261 determines that it does not exist (NO in step S193), it repeats the similar process until it determines the signal exists. Then the judgment unit 261 determines that there is a signal from the reader/writer 1 (YES in step S193), the reception unit 26 outputs information stating that there is a signal, to the control unit 21. The control unit 21 supplies power to the reception unit 26, and the decoding unit 211.

The reception unit 26 receives the control signal including an acquisition request instruction, and after demodulating the received control signal, outputs it to the control unit 21 through the decoding unit 211 (step S194). Meanwhile, supply of power to the reception unit 26 is stopped after the detection time has passed. The control unit 21 activates the control program 22P (step S195). The control unit 21 supplies power to the storage unit 25, the data storage unit 213, the generation unit 210 and the transmission unit 28 (step S196). The control unit 21 reads out the tag ID stored in the tag ID storage unit 215 in order to determine whether the tag ID included in the control information obtained by the demodulation by the reception unit 26 is identical with the tag ID stored in the tag ID storage unit 251 of the radio tag 2 itself (step S197). The control unit 21 determines whether or not the read-out tag ID and the tag ID stored in the control information match (step S1970). When the control unit 21 determines that they do not match (NO in step S1970), the control signal is discarded (step S1971). When the control unit 21 determines that they match (YES in step S1970), the process is shifted to step S198.

The control unit 21 determines whether or not there are any unsent temperature data in the data storage unit 213 (step S198). When the control unit 21 determines that there is no unsent temperature data in the data storage unit 213 (NO in step S198), it sends a signal stating that there is no unsent temperature data, together with the tag ID, to the reader/writer 1 (step S1981). When the control unit 21 determines that it exists (YES in step S198), it reads the temperature data corresponding to the data size per one transmission included in the control information, from the data storage unit 213 (step S199). The control unit 21 judges whether there still remains any unsent data after the reading out corresponding to the data size per one transmission, and generates the unsent data presence/absence information (step S200). Meanwhile, when there remains unsent data, information indicating “presence” is generated as the unsent data presence/absence information, and when there remains no unsent data, information indicating “absence” is generated as the unsent data presence/absence information. The control unit 21 stores the extension time stored in the control information in the extension time storage unit 23 (step S201). Next, the control unit 21 stores the RW identifier of the reader/writer 1 stored in the control information in the memory (step S202). The control unit 21 generates response information including the read-out tag ID, unsent data presence/absence information and temperature data (step S203).

The control unit 21 outputs the response signal to the transmission unit 28. The transmission unit 28 modulates the response information, and transmits the response signal after the modulation to the reader/writer 1 (step S204). After that, the control unit 21 stops power supply to the storage unit 25, the data storage unit 213 of the sensor 212, the generation unit 210 and the transmission unit 28 (step S206). The control unit 21 refers to the extension time stored in the extension time storage unit 23 after the transmission of the response signal, and supplies power to the reception unit 26 during the extension time, to extend the detection time (step S207).

The control unit 11 of the reader/writer 1 determines whether or not the response signal has been received (step S208). When the control unit 11 determines that the response signal has not been received (NO in step S208), it determines whether or not a constant time has passed after the transmission of the control signal by step S192 (step S2081). When the control unit 11 determines that the constant time has not passed (NO in step S2081), it returns the process to step S208. On the other hand, when the control unit 11 determines that the constant time has passed (YES in step S2081), the process is terminated as timeout.

When the control unit 11 determines that the response signal has been received from the radio tag 2 (YES in step S208), the tag ID included in the response signal, and the time output from the clock unit 13 at the time of the reception are stored in the data storage buffer 121 (step S209). The control unit 11 further attaches a sequence number to the temperature data stored in the response signal in the order of reception, and stores the temperature data in the data storage buffer 121 in numerical order (step S211). The control unit 11 calculates the total value of the data size of the temperature data stored in the data storage buffer 121. The control unit 11 determines whether or not the calculated data size has reached the total data size taken out in step S1860, or, whether or not a signal stating that there is no unsent temperature data according to step S1981 has been received (step S212). Meanwhile, the flowchart presents an example in which the total value of the received data size is calculated every time reception is performed, and whether or not the calculated total value has reached the total data size is determined. However, the embodiment is not limited to the example, and instead of the process in step S212, it may be determined that the temperature data according to the total data size when the number stored in step S211 has reached the number of division (for example, eight) obtained by dividing the total data size by the data size per one transmission.

When the control unit 11 determines that the total data size has not reached and that the signal stating that there is no unsent temperature data has not been received (NO in step S212), the control step 11 transmits a control signal including an acquisition request instruction generated in the similar manner as in the step S191 with a value obtained by adding 1 to the sequence number of the received data being the next sequence number, before the extension time has passed since the response signal was received in step S208 (step S213). The control unit 21 of the radio tag 2 determines whether or not the extension time has passed (step S214). When the control unit 21 determines that the extension time has not passed (NO in step S214), it receives the control signal transmitted in step S213 (step S215). The control unit determines whether or not the RW identifier included in the control signal matches the RW identifier stored in step S202 (step S216).

When the control unit 21 determines that they do not match (NO in step S216), the control signal is discarded as a control signal from another reader/writer 1 (step S217). After that, the control unit 21 returns the process to step S214. When the control unit 21 determines that they match (YES in step S216), it determines whether or not the control signal includes an acquisition request instruction according to this embodiment (step S218). When the control unit 21 determines that the control signal does not include an acquisition request instruction (NO in step S218), the control signal is discarded as it disturbs data collection (step S219). After that, the control unit 21 returns the process to step S214.

When the control unit 21 determines that the control signal includes an acquisition request instruction (YES in step S218), shift to step S196 is performed, and repeats the reading out and transmission of temperature data corresponding to the sequence number included in the control signal. When the control unit 11 of the reader/writer 1 determines that the total data size has reached or when it determines that a signal stating that there is no unsent temperature data according to step S1981 has been received (YES in step S212), shift to step S221 is performed.

The control unit 11 reads out all the data including the temperature data stored in the data storage buffer 121 (step S221). The control unit 11 transmits all the read-out data to the personal computer 3 (step S222). The CPU 31 of the personal computer 3 stores all the received data in the storage unit 35 (step S223). Meanwhile, the CPU 21 displays the temperature data stored in the storage unit 35 on the display unit 24 as specified in the application program (step S224).

After the process in step S222, and when it is determined that the extension time has passed in step S214 (YES in step S214), the process is shifted to step S225. The control unit 21 supplies power to the reception unit 26 by the activation unit 29 for a time period at a constant time interval (step S225). Accordingly, the radio tag 2 resumes carrier sense according to the normal detection time.

Embodiment 2 is as described above, and other parts are similar to embodiment 1, so the same reference numbers are assigned to the corresponding parts, and detail explanation is omitted for them. In addition, while temperature data are read out from the start address managed within the tag (example: the head address of the log memory) since the acquisition request instruction does not include specification of the start address of temperature data in this embodiment, the acquisition request instruction may include the start address specification, and temperature data may be read out from the specified start address.

### Embodiment 3

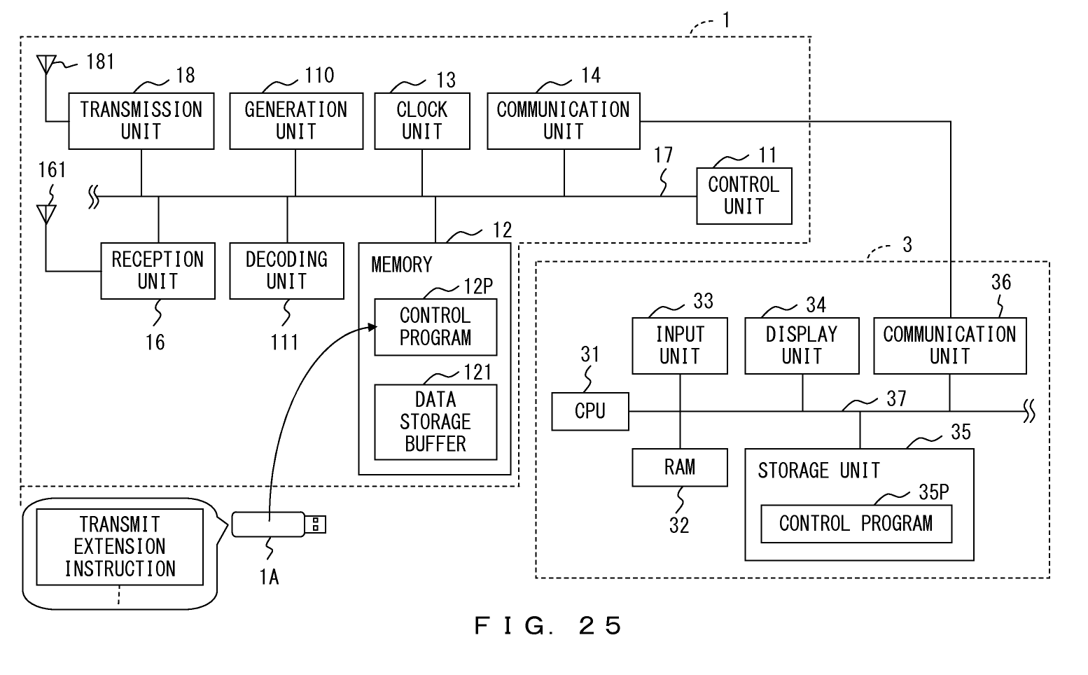

FIG. 25 is a block diagram presenting the reader/writer 1 and the personal computer 3 according to embodiment 3. The program for making the reader/writer 1 according to embodiment 3 operate may be provided by a portable recording medium 1A such as a memory card or a USE memory. Furthermore, the program may be downloaded from the personal computer 3 or another computer (not shown in the drawing) through a communication network. Details are explained below.

The portable recording medium 1A storing a program for executing transmission of an extension instruction and so on is inserted into the communication unit 14 of the reader/writer 1 presented in FIG. 25, to install the program in the control program 12P of the memory 12. Alternatively, such a program is downloaded from the personal computer 3 or another computer (not shown in the drawing) through the communication unit 14, and may be installed in the control program 12P of the memory 12. Such a program is loaded and executed in the memory 12. Accordingly, the reader/writer 1 functions as described above.

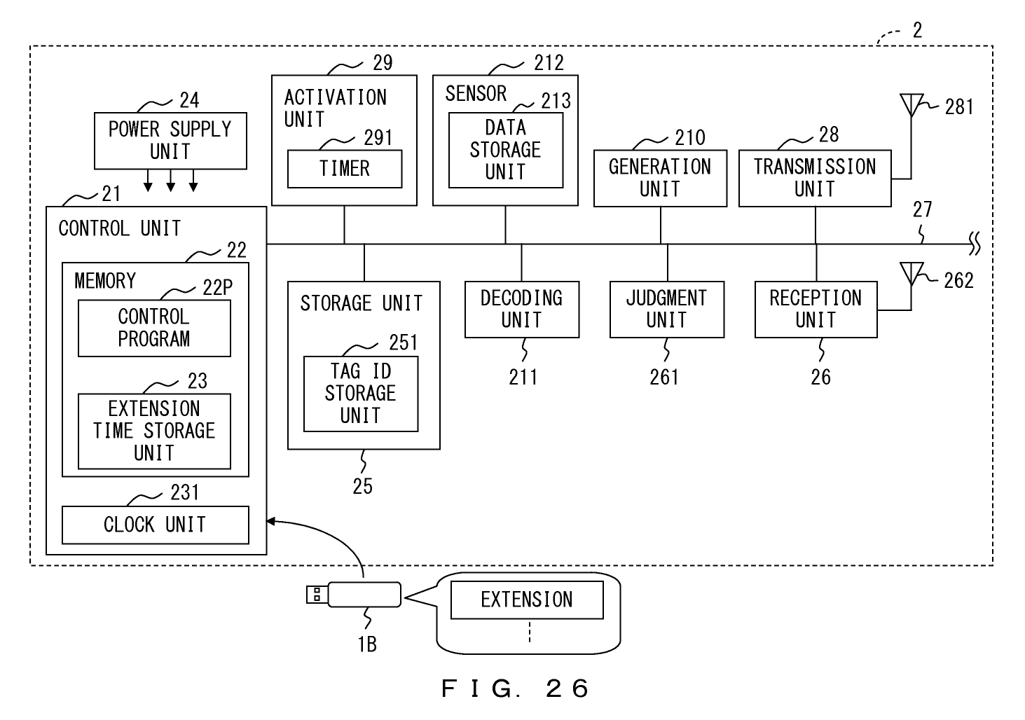

FIG. 26 is a block diagram presenting the radio tag 2 according to embodiment 3. The program for making the radio tag 2 operate may be provided by a portable recording medium 1B such as a memory card or a USB memory. Furthermore, the program may be downloaded from the reader/writer 1 and the like. Details are explained below.

The portable recording medium 1B storing a program for execution of extension and so on is inserted into a portable recording medium reading unit of the radio tag 2 that is not shown in the drawing to install the program in the control program 22P of the memory 22. Alternatively, such a program may be downloaded from the reader/writer 1 through the reception unit 26 to install it in the control program 22P of the memory 22. Such a program is loaded and executed in the memory 22. Accordingly, the radio tag 2 functions as described above.

Embodiment 3 is as described above, and other parts are similar to embodiment 1 and embodiment 2, so the same reference numbers are given to corresponding parts and detailed explanation for them are omitted.

### Embodiment 4

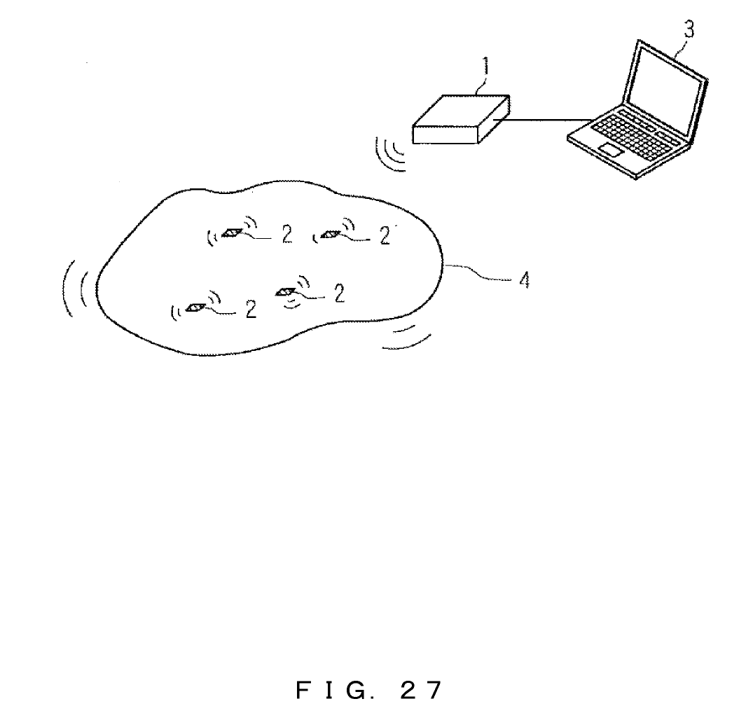

Embodiment 4 relates to an embodiment in which time setting and data collection are performed for a plurality of radio tags 2. FIG. 27 is an illustration diagram presenting the configuration of the transmission/reception system according to embodiment 4. The radio tag 2 in embodiment 4 is attached to a management target such as a liquid, a fluid, a machine, a human body or a living body (hereinafter, referred to as a moving object). The radio tags 2 are attached to the moving object 4 directly or through an attachment body such as a sticker or clothing, and detect temporal variation of the temperature of each part of the moving object 4 by the embedded sensor 212. Meanwhile, the radio tags 2 may be attached to a plurality of moving objects 4. Meanwhile, explanation is made with an example in which the sensor 212 detects the temperature in this embodiment as well, but the acceleration and so on may also be detected. In addition, a position detection sensor such as Global Positioning System (GPS) may be attached to the moving object 4 to detect temporal variation of position information.

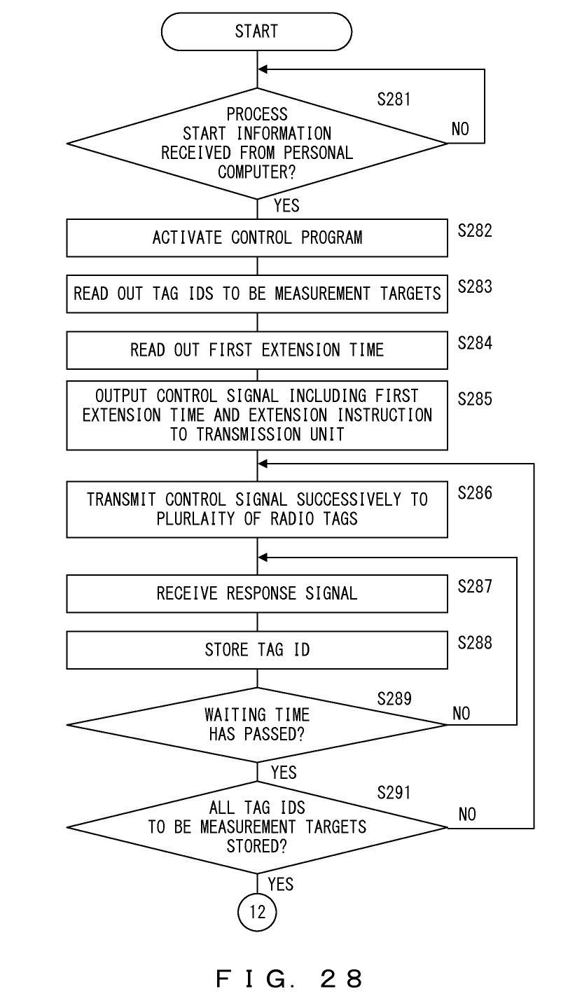

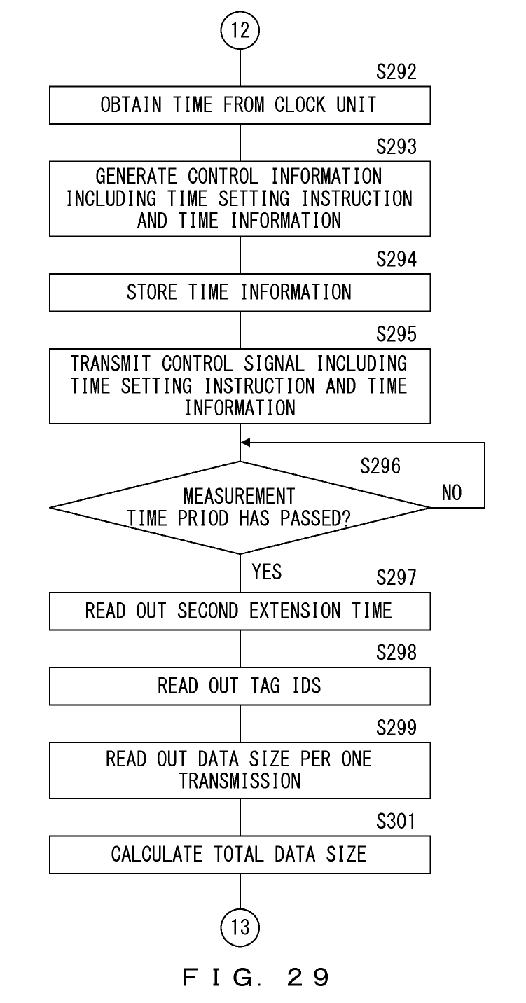

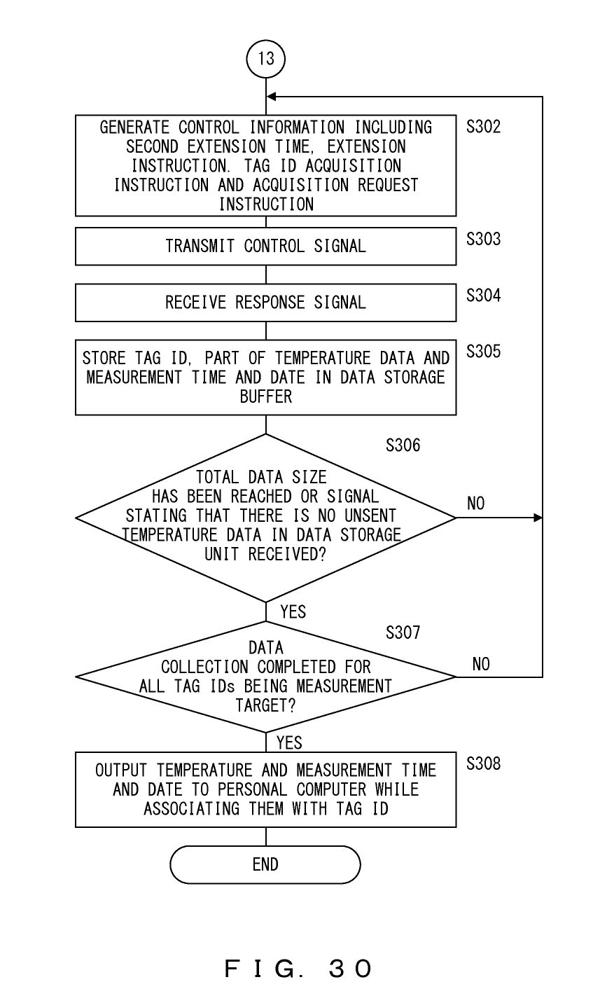

FIG. 28 through FIG. 30 are a flowchart presenting the procedure of the data collection process according to embodiment 4. The control unit 11 of the reader/writer 1 determines whether or not process start information stating the start of the process has been received from the personal computer 3 through the communication unit 14 (step S281). When the control unit 11 determines that it has not been received (NO in step S281), it waits until the process start information is received. On the other hand, when the control unit 11 determines that the process start information (YES in step S281), the control program 12P is activated (step S282). The control unit 11 reads out the tag IDs of the plurality of radio tags 2 to be the measurement targets (step S283). Meanwhile, the tag IDs of the radio tags 2 to be the measurement targets have been transmitted from the personal computer 3 and stored in the memory 12 in advance.

The control unit 11 reads out the first extension time described in embodiment 1 from the memory 12 (step S284). The control unit 11 outputs control information including the first extension time and an extension instruction to the transmission unit 18 (step S285). The transmission unit 18 successively transmits the control signal after the modulation to the plurality of radio tags 2 (step S286). Each of the radio tags 2 transmits the response signal sequentially and performs extension of the detection time. The control unit 11 receives, from the reception unit 16, the response signal transmitted from the plurality of radio tags 2 (step 287).

The control unit 11 stores the tag ID described in the response signal in the memory 12 every time it receives the response signal (step S288). The control unit 11 determines whether or not the waiting time has passed (steps S289). When the control unit 11 determines that the waiting time has not passed (NO in step S289), the process returns to step S287, and reception of the response signal is repeated. On the other hand, when the control unit 11 determines that the waiting time has passed (YES in step S289), it determines whether or not the tag IDs of all the radio tags 2 to be the measurement targets have been stored (step S291). Specifically, the control unit 11 makes the determination by whether or not the tag IDs read out in step S283 and the tag IDs stored by step S288 are identical.

When the control unit 11 determines that all the tag IDs have not been stored (NO in step S291), shift to step S286 again is performed, and a control signal is resent. When the control unit 11 determines that all the tag IDs are stored (YES in step S291), it obtains time information output from the clock unit 13 (step S292). The control unit 11 generates control information including a time setting instruction and the time information (step S293). The control unit stores the time information in the memory 12 (step S294).

The control unit 11 outputs the control information including the time setting instruction and the time information to the transmission unit 18. The transmission unit 18 transmits the control information including the time setting instruction and the time information simultaneously to all the radio tags 2 (step S295). The control unit 21 of the radio tags 2 updates the current time of the clock unit 231 according to the time information included in the control information. Accordingly, the same time is set in all the radio tags 2 within the extended detection time. The sensor 212 regularly detects the temperature and stores the time information output from the clock unit 231 of the control unit 21 as the measurement time together with the temperature data. Accordingly, the temperature change of each part of the moving object 4 to which each of the radio tags 2 is attached can be understood in time series.

The control unit 11 determines whether or not the measurement time period has passed (step S296). The measurement time period is for example 30 minutes, and whether or not the measurement time period has passed is determined assuming the time information stored in step S294 as the measurement start time. The control unit 11 refers to the output of the clock unit 13, and when it determines that the measurement time period has passed (NO in step S296), it waits until the measurement time period has passed. On the other hand, when the control unit 11 determines that the measurement time period has passed (YES in step S296), it reads out the second extension time that is shorter than the first extension time read out in step 284, from the memory 12 (step S297).

The control unit 11 performs collection of temperature data described in embodiment 2 for each of the radio tags 2 while specifying the tag ID. The control unit 11 reads out the tag IDs of the radio tags 2 to be the measurement targets stored in the memory 12 (step S298). The control unit 11 reads out the data size per one transmission from the memory 12 (step S299). Furthermore, the control unit 11 calculates (or reads out) the total data size from the measurement time period, the sampling period and the data size per one time (step S301). The control unit 11 generates control information including the second extension time and the acquisition request instruction (step S302). Meanwhile, a tag ID is described in the control information in order to specify the radio tag 2 to be the collection target for temperature data. When the tag ID in the control information matches the tag ID stored in the tag ID storage unit 251, the control unit 21 performs extension of the detection time and the divided transmission of the temperature data.

The control unit 11 outputs the control information to the transmission unit 18. The transmission unit 18 transmits the control signal after modulation to the radio tag 2 (step S303). After that, through the process described in embodiment 2, the control unit 11 receives the response signal from the radio tag 2 (step S304). The control unit 11 stores the tag ID, a part of temperature data and the measurement time of the temperature data in the data storage buffer 121 (step S305). The control unit 11 determines whether or not the total data size has been reached, and whether or not a parameter stating that there is no unsent temperature data in the data storage unit 213 has been received from the radio tag 2 (step S306).

When the control unit 11 determines that the total data size has not been reached and that a parameter stating that there is no unsent temperature data has not been received (NO in step S306), it returns the process to step S302. By repeating the process above, it becomes possible to collect the temperature data of one radio tag 2 and the time of the measurement of each temperature data in a divided manner. When the total data size has been reached or when the parameter stating that there is no unsent temperature data has been received (YES in step S306), it shifts the process to step S308. The control unit 11 determines whether or not data collection for all the tag IDs being the measurement targets read out in step S298 has been completed (step S307).

When the control unit 11 determines that it has not been completed (NO in step S307), shift is performed to step S302 to perform the similar process for a radio tag 2 having another tag ID. In this case, the control unit 11 describes a different radio tag ID in the control information. Accordingly, in the memory 12, the temporal variation of temperature data detected by the sensor 212 of the plurality of radio tags 2 is accumulated.

When the control unit 11 determiners that the data collection has been completed for all the tag IDs being the measurement targets (YES in step S307), it transmits the temperature data and the measurement time to the personal computer 3 while associating them with the tag ID (step S308). The control unit 11 deletes the transmitted temperature data and the measurement time in the memory 12 corresponding to the tag ID. By the process described above, it becomes possible to collect data involving temporal variation accurately and efficiently from a plurality of radio tags 2 for which time setting has been made simultaneously.

Embodiment 4 is as described above, and other parts are similar to embodiment 1 through embodiment 3, so the same reference numbers are assigned to corresponding parts, and detailed explanation for them is omitted.

According to a viewpoint of the embodiments, even in a radio tag that performs detection of a signal at a constant time interval with power supply for a time period, the time for reception is extended due to an extension instruction for the time period from the reader/writer. Accordingly, the embodiments have advantageous effects such as that the signal reception timing for example for a plurality of radio tags may be controlled efficiently, and also that at the reader/writer side, it becomes possible to collect information from radio tags efficiently.

All examples and conditional languages recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A reader/writer for transmitting/receiving a signal to/from a radio tag, the reader/writer comprising:
a transmission unit configured to transmit, to an active-type radio tag to perform detection of a signal at a constant time interval by supplying power to a reception unit from a power supply unit for a time period, a signal including an instruction to temporarily extend the time period.

2. The reader/writer according to claim 1, further comprising:
a reception unit configured to receive, from the radio tag, a response signal to the signal transmitted by the transmission unit; and
a time transmission unit configured to transmit, when the response signal is received by the reception unit, a signal including time information output from a clock unit and an instruction to set a time according to the time information.

3. The reader/writer according to claim 2, wherein
an extension time of the time period is a time period longer than the constant time interval.

4. The reader/writer according to claim 2, wherein
the reception unit receives, from each of a plurality of tags, the response signal to the signal transmitted by the transmission unit to each of the plurality of radio tags, and
the transmission unit transmits the signal including the time information output from the clock unit and the instruction to set the time according to the time information after elapse of an waiting time that begins when the reception unit receives a first response signal from one of the plurality of radio tags, the waiting time being determined on the basis of an extension time of the time period.

5. The reader/writer according to claim 4, wherein
the waiting time is obtained by subtracting an auxiliary time from the extension time or by multiplying the extension time by a coefficient.

6. The reader/writer according to claim 1, wherein
the transmission unit transmits to the radio tag, a signal including an instruction to extend the time period and an acquisition request instruction for data stored in the radio tag.

7. The reader/writer according to claim 6, wherein
an extension time of the time period is a time period shorter than the constant time interval.

8. The reader/writer according to claim 6, wherein
the transmission unit transmits to the radio tag, the signal including the instruction to extend the time period and the acquisition request instruction for dividing and transmitting the data stored in the radio tag in multiple times.

9. The reader/writer according to claim 8, further comprising
a reception unit to receive a response signal including divided data from the radio tag corresponding to the signal transmitted by the transmission unit,
wherein
the transmission unit transmits to the radio tag, the signal including the instruction to extend the time period and the acquisition request instruction for dividing and transmitting the data stored in the radio tag in multiple times again during a period before elapse of an extension time of the time period after the response signal is received by the reception unit.

10. A radio tag for transmitting/receiving a signal to/from a reader/writer, the radio tag comprising:
a power supply unit;
a reception unit configured to receive power supplied from the power supply unit for a time period and to detect a signal transmitted from the reader/writer at a constant time interval; and
an extension unit configured to temporarily extend the time period, when the reception unit receives a signal including an instruction to temporarily extend the time period.

11. The radio tag according to claim 10, further comprising
a time reception unit configured to receive a signal including time information transmitted from the reader/writer and an instruction to set a time according to the time information within a time period extended by the extension unit.

12. The radio tag according to claim 11, wherein
an extension time of the time period is a time period longer than the constant time interval.

13. The radio tag according to claim 11, further comprising
a unit configured to discard a signal transmitted from another reader/writer being different from the reader/writer when the signal transmitted from the other reader/writer is received by the reception unit in the time period extended by the extension unit.

14. The radio tag according to claim 10, further comprising
a data transmission unit configured to read out data stored in a storage unit and transmit the data to the reader/writer, when a signal including an instruction to extend the time period and an acquisition request instruction for the data stored in the storage unit is received by the reception unit.

15. The radio tag according to claim 10, wherein
an extension time of the time period is a time period shorter than the constant time interval.

16. The radio tag according to claim 14, wherein
the data transmission unit reads out data specified by a designated sequence number among the data stored in the storage unit when the signal including the instruction to extend the time period and the acquisition request instruction for dividing and transmitting the data stored in the storage unit in multiple times is received by the reception unit, and transmits the read-out part of the data to the reader/writer.

17. The radio tag according to claim 14, wherein
the extension unit temporarily extend the time period after the data is transmitted by the data transmission unit.

18. A recording medium storing a program used in a computer that controls a reader/writer for receiving/transmitting a signal to/from a radio tag, the program making the computer to perform:
transmitting to an active-type radio tag to perform detection of a signal at a constant time interval by supplying power to a reception unit from a power supply unit for a time period, a signal including an instruction to temporarily extend the time period.

19. A recording medium storing a program used in a computer that controls a radio tag comprising a reception unit to receive power supplied from a power supply unit for a time period and to detect a signal transmitted from a reader/writer at a constant time interval, the program making the computer to perform:
temporarily extending the time period when the reception unit receives a signal including an instruction to temporarily extend the time period.

20. A transmission/reception system for transmitting/receiving a signal between a radio tag and a reader/writer, wherein
the radio tag comprises:
a power supply unit; and
a reception unit configured to receive power supplied from the power supply unit for a time period and to detect a signal transmitted from the reader/writer at a constant time interval, and
the reader/writer comprises
a transmission unit configured to transmit a signal including an instruction to temporarily extend the time period, and
the radio tag comprises
an extension unit configured to temporarily extend the time period when the reception unit receives the signal including the instruction to temporarily extend the time period transmitted from the transmission unit.

21. A transmission/reception method for transmitting/receiving a signal between a radio tag and a reader/writer, the method comprising:
supplying power from a power supply unit of a radio tag to a reception unit for a time period and performing detection of a signal transmitted from the reader/writer at a constant time interval;
transmitting a signal including an instruction to temporarily extend the time period from the reader/writer to the radio tag; and
temporarily extending the time period by the radio tag when the reception unit of the radio tag receives the signal including the instruction to temporarily extend the time period.

22. A reader/writer for transmitting/receiving a signal to/from a plurality of radio tags, the reader/writer comprising:
a first transmission unit configured to transmit, to a plurality of active-type radio tags to perform detection of a signal at a constant time interval by supplying power from a power supply unit to a reception unit for a time period, a signal including an instruction to temporarily extend the time period;
a reception unit configured to receive a response signal to the signal transmitted by the first transmission unit from the plurality of radio tags;
a time transmission unit configured to transmit, when the response signal is received by the reception unit, a signal including time information output from a clock unit and an instruction to set a time according to the time information simultaneously to the plurality of radio tags; and
a second transmission unit configured to transmit, to a radio rag to which the signal is transmitted by the time transmission unit, a signal including an instruction to extend the time period and an acquisition request instruction for dividing and transmitting data stored in the radio tag in multiple times.
